SEQUENCE LISTING (9 sequences)

SEQ ID NO: 1 - DNA, 20 bp, artificial sequence
  aP2 forward primer
ggcatggccaaacctaacat

SEQ ID NO: 2 - DNA, 21 bp, artificial sequence
  aP2 reverse primer
ttccatcccatttctgcacat

SEQ ID NO: 3 - DNA, 21 bp, artificial sequence
  FABP-5 forward primer
gcaatggccaagccagattgt

SEQ ID NO: 4 - DNA, 20 bp, artificial sequence
  FABP-5 reverse primer
cccatcccactcctgatgct

SEQ ID NO: 5 - DNA, 20 bp, artificial sequence
  GAPDH forward primer
gacatcaagaaggtggtgaa

SEQ ID NO: 6 - DNA, 20 bp, artificial sequence
  GADPH reverse primer
tgtcataccaggaaatgagc

SEQ ID NO: 7 - DNA, 39 bp, artificial sequence
  T7 RNA polymerase promoter sequence
ggccagtgaattgtaatacgactcactatagggaggcgg

SEQ ID NO: 8 - DNA, 634 bp, human
ggaattccaggagggtgcagcttccttctcaccttgaagaataatcctagaaaactcacaaaatgtgtgatgcttttgtaggtacctggaaacttgtctccagtgaaaactttgatgattatatgaaagaagtaggagtgggctttgccaccaggaaagtggctggcatggccaaacctaacatgatcatcagtgtgaatggggatgtgatcaccattaaatctgaaagtacctttaaaaatactgagatttccttcatactgggccaggaatttgacgaagtcactgcagatgacaggaaagtcaagagcaccataaccttagatgggggtgtcctggtacatgtgcagaaatgggatggaaaatcaaccaccataaagagaaaacgagaggatgataaactggtggtggaatgcgtcatgaaaggcgtcacttccacgagagtttatgagagagcataagccaagggacgttgacctggactgaagttcgcattgaactctacaacattctgtgggatatattgttcaaaaagatattgttgttttccctgatttagcaagcaagtaattttctcccaagctgattttattcaatatggttacgttggttaaataactttttttagatttag

SEQ ID NO: 9 - DNA, 662 bp, human
accgccgacgcagacccctctctgcacgccagcccgcccgcacccaccatggccacagttcagcagctggaaggaagatggcgcctggtggacagcaaaggctttgatgaatacatgaaggagctaggagtgggaatagctttgcgaaaaatgggcgcaatggccaagccagattgtatcatcacttgtgatggtaaaaacctcaccataaaaactgagagcactttgaaaacaacacagttttcttgtaccctgggagagaagtttgaagaaaccacagctgatggcagaaaaactcagactgtctgcaactttacagatggtgcattggttcagcatcaggagtgggatgggaaggaaagcacaataacaagaaaattgaaagatgggaaattagtggtggagtgtgtcatgaacaatgtcacctgtactcggatctatgaaaaagtagaataaaaattccatcatcactttggacaggagttaattaagagaatgaccaagctcagttcaatgagcaaatctccatactgtttctttcttttttttttcattactgtgttcaattatctttatcataaacattttacatgcagctatttcaaagtgtgttggattaattaggatcatccctttggttaataaataaatgtgtttgtgct

(19) United States
(12) Patent Application Publication
(10) Pub. No.: US 2007/0043512 A1
(43) Pub. Date: Feb. 22, 2007

(54) Therapeutic and prophylactic compositions and uses therefor

(76) Inventors: Michael Rolph, New South Wales (AU); Charles Mackay, New South Wales (AT)

Correspondence Address: JENNIFER M MCCALLUM, PH D, ESQ;THE MCCALLUM LAW FIRM, LLC, 685 BRIGGS STREET, PO BOX 929, ERIE, CO, 80516, US

(21) Appl. No.: 10/550,721

(22) PCT Filed: Mar. 26, 2004
(86) PCT No.: PCT/AU04/00374

§ 371 Date: Jul. 17, 2006

Related U.S. Application Data
(60) Provisional application No. 60/458,060, filed on Mar. 26, 2003.

(51) Int. Cl. G06F 19/00

(52) U.S. Cl. 702/20

(57) ABSTRACT

The present invention relates generally to compositions and their use in the treatment and/or prophylaxis of inflammatory conditions in an animal such as a mammal, including a human. More particularly, the compositions of the present invention comprise agents which modulate the level of expression of genes or the level of activity of gene products involved in eliciting an inflammatory response and in particular an asthmatic condition. The present invention also provides methods for identifying additional agents which interact with selected target genes or target gene products, the regulation of which, provide useful means for treating and/or preventing the development of an inflammatory condition such as asthma. Furthermore, methods of treatment and/or prophylaxis in an animal such as a mammal including a human, by the administration of a composition of the present invention, are provided.

### BACKGROUND OF THE INVENTION

1. Field of the Invention

The present invention relates generally to compositions and their use in the treatment and/or prophylaxis of inflammatory conditions in an animal such as a mammal, including a human. More particularly, the compositions of the present invention comprise agents which modulate the level of expression of genes or the level of activity of gene products involved in eliciting an inflammatory response and in particular an asthmatic condition. The present invention also provides methods for identifying additional agents which interact with selected target genes or target gene products, the regulation of which, provide useful means for treating and/or preventing the development of an inflammatory condition such as asthma. Furthermore, methods of treatment and/or prophylaxis in an animal such as a mammal including a human, by the administration of a composition of the present invention, are provided.

2. Description of the Prior Art

Bibliographic details of the publications referred to in this specification are also collected at the end of the description.

Reference to any prior art in this specification is not, and should not be taken as, an acknowledgment or any form of suggestion that this prior art forms part of the common general knowledge in any country.

The bronchial epithelium acts as a crucial barrier to the external environment, providing an early line of defence against inhaled particles, both harmful and benign. It acts as a physical barrier, an activity that is enhanced by its ability to produce protective molecules such as mucus and defensins (Davies, Curr. Opin. Allergy Clin. Immunol. 1(1): 67-71, 2001). However, the bronchial epithelium plays an even broader role in lung physiology since it is involved in diverse processes such as production and remodelling of the extracellular matrix (ECM) and leukocyte migration into the airways.

Chronic inflammation is a characteristic feature of asthma, an inflammatory, allergic disease characterized by airway hyper-responsiveness, airflow obstruction and airway inflammation. During asthma, there is marked infiltration of the bronchial mucosa by eosinophils, lymphocytes and mast cells. Other changes include epithelial desquamation, goblet cell hyperplasia and thickening of the submucosa.

The incidence of asthma in Western countries has increased markedly over the last 20 years, such that in many countries it affects up to 25% of all children (Woolcock, Lancet 351: 1225, 2001). While the incidence continues to rise, and the associated costs continue to increase, there has been less of an advance in our understanding and ability to combat effectively the symptoms of this disease. The features of the allergic inflammatory response that ultimately lead to the clinical features of asthma are still not fully understood.

Some features, however, are known. Mast cells, eosinophils and T lymphocytes are the major inflammatory cells present in the asthmatic lung. In response to allergen exposure, mast cells can become activated within minutes through the Fc receptor, FcεR1. This leads to rapid release of a broad range of bioactive factors such as histamine, prostaglandin D2, leukotriene C4 and platelet activating factor which are thought to be responsible for much of the immediate allergic response (Wills-Karp, Annu. Rev. Immunol. 17: 255-281, 1999). Mast cells also produce a broad range of cytokines that are probably involved in the late-phase response (Wills-Karp, 1999, supra). Eosinophils are prominent in the asthmatic lung, and although their role has recently been questioned (Leckie et al., Lancet 356(9248): 2144-2148, 2000), they also elaborate a broad range of inflammatory mediators with the potential to contribute to the pathogenesis of asthma. Th2 cells are thought to be pivotal in regulating much of the allergic inflammation of asthma through the production of cytokines such as IL-4, IL-5, IL-9 and IL-13. For example, both IL-4 (Finkelman et al. J. Immunol. 141(7): 2335-2341, 1988) and IL-13 (Punnonen et al., Proc. Natl. Acad. Sci. USA 90(8): 3730-3740, 1993) can direct the production of IgE by B lymphocytes (Foster et al., Pharmacol. Ther. 94(3): 253-264, 2002), while IL-5 acts specifically on eosinophils to promote their maturation in the bone marrow and subsequent transit through the vasculature to the lung (Foster et al., 2002, supra).

However, in the context of allergic inflammation, infiltrating cells such as mast cells, eosinophils and Th2 cells do not act alone. Most of the deleterious effects of these cells in allergic inflammation are ultimately mediated through their interaction with lung parenchymal cells, such as bronchial epithelial cells, smooth muscle cells and fibroblasts. Yet the precise mechanisms by which allergic inflammatory cells mediate their effects on lung parenchymal cells are still not well characterized. During asthma, the bronchial epithelium is clearly damaged (Holgate et al., Clin. Exp. Allergy 29(2): 90-95, 1999). However, it is not known whether changes in bronchial epithelium during asthma are primary or secondary effects.

Given the increasing prevalence of this physiologically and clinically debilitating condition, there is clearly a need to find more efficacious ways to treat and, preferably, prevent the onset of the symptoms associated with an inflammatory response and in particular asthma.

### SUMMARY OF THE INVENTION

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

Nucleotide and amino acid sequences are referred to by a sequence identifier number (SEQ ID NO:). The SEQ ID NOs: correspond numerically to the sequence identifiers <400>1 (SEQ ID NO:1), <400>2 (SEQ ID NO:2), etc. A summary of the sequence identifiers is provided in Table 1. A sequence listing is provided at the end of the specification.

In accordance with the present invention, it is determined that a number of specific genes are differentially expressed in one or more tissues during an inflammatory response compared with such tissue in its normal non-inflamed state. Hence, it is proposed that up-regulation or down-regulation of particular genes leads to, or at least contributes to, an inflammatory response and, in particular, an inflammatory asthmatic response. It is proposed, therefore, that the treatment and/or prophylaxis of inflammatory conditions in certain organs and tissues may be effected via modulation of the level of expression of one or more of these target genes and/or the activity of a gene expression product. The genes in effect represent a genetic data set comprising one or more nucleotide sequences which are differentially expressed in cells from inflamed tissue relative to cells from non-inflamed tissue. One of the nucleotide sequences or all or part of the data set or the pattern of expression of one or more elements in the data set may, therefore, be used to develop diagnostic protocols for inflammatory conditions or a propensity for development of inflammatory conditions.

The present invention provides, therefore, agents which modulate either the level of expression of a target gene or the activity of a gene expression product for use in the treatment and prophylaxis of inflammation or inflammatory conditions. A particularly important inflammatory condition and one contemplated by the present invention is asthma. The agents are conveniently in the form of a composition comprising the agent and one or more pharmaceutically acceptable carriers, diluents and/or excipients.

An agent may be a chemical agent such as a chemical molecule or peptide, polypeptide or protein or chemical analogs thereof or may be a genetic agent such as a sense or antisense molecule, ribozyme, DNAzyme or ribonuclease-type complex.

The present invention provides a range of target genes or target gene products, the modulation of the level of expression and/or the activity of which, is expected to result in a reduction in the extent and/or severity of an inflammatory response such as asthma. Particularly preferred target genes include, but are not limited to, those designated “aP2” and “FABP-5”. The gene designated “aP2” (adipocyte lipid-binding protein 2) is also known as “FABP4” and “ALBP”. The cDNA sequence from aP2 is shown in SEQ ID NO:8. The gene designated “FABP-5” is also known as “E-FABP” and “mal1” and comprises an mRNA sequence set forth in SEQ ID NO:9. The term “FABP” is an abbreviation of “fatty acid binding protein”. The genetic data set may be derived from any source including human and non-human mammalian animal. Even a data set of non-human mammalian animal genetic elements, if these have homologs in human cells, may be useful for diagnostic purposes or for identifying drug targets.

Another aspect of the present invention is directed to methods for identifying agents, which modulate the level of expression of and/or the activity of an expression product of a target gene.

The agents of the present invention which are capable of modulating the level of expression of and/or the activity of an expression product of a target gene and compositions comprising same, may be used systemically or locally such as topically.

A summary of sequence identifiers used throughout the subject specification is provided in Table 1.

TABLE 1
Summary of sequence identifiers

| SEQUENCE ID NO: | DESCRIPTION |
|---|---|
| 1 | aP2 forward primer |
| 2 | aP2 reverse primer |
| 3 | FABP-5 forward primer |
| 4 | FABP-5 reverse primer |
| 5 | GAPDH forward primer |
| 6 | GADPH reverse primer |
| 7 | T7 RNA polymerase promoter primer |
| 8 | cDNA sequence of human aP2 |
| 9 | mRNA sequence of human FABP-5 |

### BRIEF DESCRIPTION OF THE FIGURES

FIG. 1 is a graphical representation showing aP2 gene expression following IL-4 and IL-13 stimulation. NHBE were stimulated with 10 ng/ml IL-4 or 10 ng/ml IL-13. At the indicated times, aP2 gene expression was measured and compared to unstimulated cells. Results are mean±SEM from 3 independent experiments, except 1, 48 and 72 h for IL-4, and 18 h for IL-13 where n=2.

FIG. 2 is a graphical representation showing cytokine regulation of aP2 expression in NHBE cells. NHBE cells were stimulated with a range of stimuli for 18 h after which aP2 gene expression was measured by real-time PCR. Results are the mean from two independent experiments.

FIG. 3 is a graphical representation showing FABP-5 gene expression following IL-4 and IL-13 stimulation. NHBE were stimulated with (A) 10 ng/ml IL-4 or (B) 10 ng/ml IL-13. At the indicated times, FABP-5 gene expression was measured and compared to unstimulated cells. Results are (A) mean from two independent experiments, and (B) mean±SEM from three independent experiments, except one and 72 h where n=2.

FIG. 4 is a photomicrograph showing increased expression, and nuclear localization, of aP2 in response to IL-4 or IL-13 stimulation. NHBE cells were treated with (A) culture medium only, (B) 10 ng/ml IL-4 or (C) 10 ng/ml IL-13. After 24 h, the cells were stained for aP2 as described in the Examples. For each experimental group the isotype control was negative.

FIG. 5 is a photomicrograph showing aP2 expression in airways of (A) PBS- or (B) OVA-challenged mice. Figures are representative of results from five PBS- and three OVA-treated mice. For both experimental groups, isotype controls were negative.

FIG. 6 is a graphical representation showing aP2 expression in THP-1 cells stimulated with (A) 10 ng/ml IL-4, 10 ng/ml IL-13 or 28 ng/ml IFN-γ or (B) 50 ng/ml PMA. The data are mean±SEM from three independent experiments.

### DETAILED DESCRIPTION OF THE PREFERRED EMBODIMENTS

The present invention is predicated in part on the elucidation of differentially expressed genetic sequences associated with varying levels of an inflammatory response and in particular an asthmatic inflammatory response. Micro-array technology is utilised to analyse levels of gene expression in asthmatic and non-asthmatic tissues. In this regard, one particularly useful tissue system is cultured human bronchial epithelial cells, either treated or not treated with one or more type-2 cytokines which mediate an inflammatory response. Examples of type-2 cytokines include inter alia IL-4 and IL-13. The differentially expressed genetic sequences represent a data set or genetic data set. A genetic data set comprises one or more differentially expressed nucleotide sequences such as NHBE cells or other cells cultured in the presence of one or more type 2 cytokines. Preferably, the genetic data set comprises sufficient differentially expressed nucleotide sequences to provide a pattern of expressions which reflects a “normal”, non-inflamed state and an “inflamed” state.

Accordingly, under inflammatory conditions, a range of differentially expressed genes is identified which is encompassed within a genetic data set. It is proposed, in accordance with the present invention, that the ability to modulate the level of expression of the genes or a gene activity of an expression product thereof coincides with the ability to mitigate against the on-set and/or progression of an undesirable inflammatory response. Modulation may be either via down-regulation or via up-regulation. One inflammatory response, the mitigation of which is particularly preferred, is the asthmatic response.

The terms “inflammation”, “inflammatory response” and inflammatory condition” are used interchangeably throughout this specification. Generally, although not exclusively, the inflammatory response being prevented or treated is asthma.

The present invention provides, therefore, agents which modulate either the level of expression of a target gene or the activity of a gene expression product for use in the treatment and prophylaxis of inflammation or inflammatory conditions such as asthma. The agents are conveniently in a composition comprising the agent and one or more pharmaceutically acceptable carriers, diluents and/or excipients. Two or more agents may be co-administered in the same composition or in separate compositions. Accordingly, two or more targets may be modulated simultaneously or sequentially.

Before describing the present invention in detail, it is to be understood that unless otherwise indicated, the subject invention is not limited to specific formulations of components, manufacturing methods, dosage regimens, or the like, as such may vary. It is also to be understood that the terminology used herein is for the purpose of describing particular embodiments only and is not intended to be limiting.

It must be noted that, as used in the subject specification, the singular forms “a”, “an” and “the” include plural aspects unless the context clearly dictates otherwise. Thus, for example, reference to “an active agent” includes a single active agent, as well as two or more active agents; reference to “a target gene” includes reference to two or more target genes; and so forth.

In describing and claiming the present invention, the following terminology is used in accordance with the definitions set forth below.

The terms “compound”, “active agent”, “pharmacologically active agent”, “medicament”, “active” and “drug” are used interchangeably herein to refer to a chemical compound that induces a desired pharmacological and/or physiological effect. The terms also encompass pharmaceutically acceptable and pharmacologically active ingredients of those active agents specifically mentioned herein including but not limited to salts, esters, amides, prodrugs, active metabolites, analogs and the like. When the terms “compound”, “active agent”, “pharmacologically active agent”, “medicament”, “active” and “drug” are used, then it is to be understood that this includes the active agent per se as well as pharmaceutically acceptable, pharmacologically active salts, esters, amides, prodrugs, metabolites, analogs, etc. The term “compound” is not to be construed as a chemical compound only but extends to peptides, polypeptides and proteins as well as genetic molecules such as RNA, DNA and chemical analogs thereof. The term “modulator” is an example of a compound, active agent, pharmacologically active agent, medicament, active and drug which up-regulates or down-regulated either the level of expression of a target gene or the activity of a gene expression product. The term “down-regulates” encompasses the inhibition, reduction or prevention of expression of a target gene or of the activity of an expression product of a target gene, so as to correspondingly reduce an inflammatory response such as asthma or the risk of an inflammatory response such as asthma being elicited. Such a modulator may be referred to herein as an “inhibitor”. Similarly, the term “up-regulates” encompasses the induction, increase or potentiation of expression of a target gene or of the activity of an expression product of a target gene, so as to correspondingly reduce an inflammatory response such as asthma or the risk of an inflammatory response such as asthma being elicited. Such a modulator may, therefore, be referred to herein as a “potentiator”.

The present invention contemplates, therefore, compounds useful in modulating either the level of expression of a target gene or the activity of a gene expression product. The compounds have an effect on reducing or preventing or treating inflammatory conditions. Reference to a “compound”, “active agent”, “pharmacologically active agent”, “medicament”, “active” and “drug” includes combinations of two or more actives such as one or more inhibitors and/or potentiators of either the level of expression of a target gene or the activity of a gene expression product. A “combination” also includes a two-part or more such as a multi-part pharmaceutical composition where the agents are provided separately and given or dispensed separately or admixed together prior to dispensation.

The terms “effective amount” and “therapeutically effective amount” of an agent as used herein mean a sufficient amount of the agent to provide the desired therapeutic or physiological effect. Furthermore, an “effective asthma-obviating amount” or “effective asthma symptom-obviating amount” or “effective asthma symptom-ameloriating amount” of an agent is a sufficient amount of the agent to directly or indirectly modulate the level of expression of a target gene or the activity of a gene expression product. This may be accomplished by the agents inducing or preventing the expression of a target gene; acting as an agonist of a gene expression product inhibitor or potentiator; mimicking expression product inhibitors or potentiators; or acting as an antagonist of potentiators or inhibitors of the activity of a gene expression product, inter alia. Undesirable effects, e.g. side effects, are sometimes manifested along with the desired therapeutic effect; hence, a practitioner balances the potential benefits against the potential risks in determining what is an appropriate “effective amount”. The exact amount required will vary from subject to subject, depending on the species, age and general condition of the subject, mode of administration and the like. Thus, it may not be possible to specify an exact “effective amount”. However, an appropriate “effective amount” in any individual case may be determined by one of ordinary skill in the art using only routine experimentation.

By “pharmaceutically acceptable” carrier, excipient or diluent is meant a pharmaceutical vehicle comprised of a material that is not biologically or otherwise undesirable, i.e. the material may be administered to a subject along with the selected active agent without causing any or a substantial adverse reaction. Carriers may include excipients and other additives such as diluents, detergents, coloring agents, wetting or emulsifying agents, pH buffering agents, preservatives, and the like.

Similarly, a “pharmacologically acceptable” salt, ester, emide, prodrug or derivative of a compound as provided herein is a salt, ester, amide, prodrug or derivative that this not biologically or otherwise undesirable.

The terms “treating” and “treatment” as used herein refer to reduction in severity and/or frequency of symptoms, elimination of symptoms and/or underlying cause, prevention of the occurrence of symptoms and/or their underlying cause, and improvement or remediation of damage. Thus, for example, “treating” a patient involves prevention of a particular disorder or adverse physiological event in a susceptible individual as well as treatment of a clinically symptomatic individual by inhibiting or causing regression of an inflammatory condition or disorder. Generally, such a condition or disorder is an inflammatory response or mediates or facilitates an inflammatory response or is a downstream product of an inflammatory response. Thus, for example, the present method of “treating” a patient with an inflammatory condition or with a propensity for one to develop encompasses both prevention of the condition, disease or disorder as well as treating the condition, disease or disorder. In any event, the present invention contemplates the treatment or prophylaxis of any inflammatory-type condition and, in particular, an inflammatory asthmatic condition.

“Patient” as used herein refers to an animal, preferably a mammal and more preferably human who can benefit from the pharmaceutical formulations and methods of the present invention. There is no limitation on the type of animal that could benefit from the presently described pharmaceutical formulations and methods. A patient regardless of whether a human or non-human animal may be referred to as an individual, subject, animal, host or recipient. The compounds and methods of the present invention have applications in human medicine, veterinary medicine as well as in general, domestic or wild animal husbandry. For convenience, an “animal” includes an avian species such as a poultry bird, an aviary bird or game bird. The condition in a non-human animal may not be referred to as “asthma”. However, it may nevertheless have asthma-like symptoms.

The compounds of the present invention may be large or small molecules, nucleic acid molecules (including antisense or sense molecules), peptides, polypeptides or proteins or hybrid molecules such as RNAi- or siRNA-complexes, ribozymes or DNAzymes. The compounds may need to be modified so as to facilitate entry into a cell. This is not a requirement if the compound interacts with a gene product which is an extracellular receptor.

The preferred animals are humans or other primates, livestock animals, laboratory test animals, companion animals or captive wild animals. A human is the most preferred target.

Examples of laboratory test animals include mice, rats, rabbits, guinea pigs and hamsters. Rabbits and rodent animals, such as rats and mice, provide a convenient test system or animal model. Livestock animals include sheep, cows, pigs, goats, horses and donkeys. Non-mammalian animals such as avian species, zebrafish, amphibians (including cane toads) and Drosophila species such as Drosophila melanogaster are also contemplated. Instead of a live animal model, a test system may also comprise a tissue culture system.

The present invention provides, therefore, drugs which modulate either the level of expression of a target gene or the activity of a gene expression product, including agents which agonise inhibitors or potentiators of a target gene or genes. Particularly preferred target genes in the context of the present invention include aP2 and FABP-5.

The present invention contemplates, therefore, methods of screening for drugs comprising, for example, contacting a candidate drug with a target gene or an expression product thereof. A molecule that may be a target gene and one that is an expression product thereof are both referred to herein interchangeably as a “target” or a “target molecule”. The screening procedure includes assaying (i) for the presence of a complex between the drug and a target gene, or (ii) for an alteration in the expression levels of nucleic acid molecules encoding the target expression product. Where the target gene encodes a receptor, then whole cells may also be screened for interaction between the cell and the drug.

One form of assay involves competitive binding assays. In such competitive binding assays, the target is typically labeled. Free target is separated from any putative complex and the amount of free (i.e. uncomplexed) label is a measure of the binding of the agent being tested to target molecule. One may also measure the amount of bound, rather than free, target. It is also possible to label the agent rather than the target and to measure the amount of agent binding the target in the presence and in the absence of the drug being tested. Such compounds may inhibit the target which is useful, for example, in finding inhibitors of gene expression, or may protect an expression product from being inhibited or, alternatively, may potentiate its inhibition.

Another technique for drug screening provides high throughput screening for compounds having suitable binding affinity to a target and is described in detail in Geysen (International Patent Publication No. WO 84/03564). Briefly stated, large numbers of different small peptide test compounds are synthesized on a solid substrate, such as plastic pins or some other surface. The peptide test compounds are reacted with a target and washed. Bound target molecule is then detected by methods well known in the art. This method may be adapted for screening for non-peptide, chemical entities. This aspect, therefore, extends to combinatorial approaches to screening for target antagonists or agonists.

Purified target can be coated directly onto plates for use in the aforementioned drug screening techniques. However, non-neutralizing antibodies to the target may also be used to immobilize the target on the solid phase.

The present invention also contemplates the use of competitive drug screening assays in which neutralizing antibodies capable of specifically binding the target compete with a test compound for binding to the target or fragments thereof. In this manner, the antibodies can be used to detect the presence of any peptide which shares one or more antigenic determinants of the target.

Analogs of differentially produced proteins may also be useful as antagonists. These analogs may compete for ligands and/or induce feedback inhibition.

Analogs contemplated herein include but are not limited to modification to side chains, incorporating of unnatural amino acids and/or their derivatives during peptide, polypeptide or protein synthesis and the use of crosslinkers and other methods which impose conformational constraints on the proteinaceous molecule or their analogs.

Examples of side chain modifications contemplated by the present invention include modifications of amino groups such as by reductive alkylation by reaction with an aldehyde followed by reduction with NaBH₄; amidination with methylacetimidate; acylation with acetic anhydride; carbamoylation of amino groups with cyanate; trinitrobenzylation of amino groups with 2,4,6-trinitrobenzene sulphonic acid (TNBS); acylation of amino groups with succinic anhydride and tetrahydrophthalic anhydride; and pyridoxylation of lysine with pyridoxal-5-phosphate followed by reduction with NaBH₄. The guanidine group of arginine residues may be modified by the formation of heterocyclic condensation products with reagents such as 2,3-butanedione, phenylglyoxal and glyoxal.

The carboxyl group may be modified by carbodiimide activation via O-acylisourea formation followed by subsequent derivitization, for example, to a corresponding amide.

Sulphydryl groups may be modified by methods such as carboxymethylation with iodoacetic acid or iodoacetamide; performic acid oxidation to cysteic acid; formation of a mixed disulphides with other thiol compounds; reaction with maleimide, maleic anhydride or other substituted maleimide; formation of mercurial derivatives using 4-chloromercuribenzoate, 4-chloromercuriphenylsulphonic acid, phenylmercury chloride, 2-chloromercuri-4-nitrophenol and other mercurials; carbamoylation with cyanate at alkaline pH.

Tryptophan residues may be modified by, for example, oxidation with N-bromosuccinimide or alkylation of the indole ring with 2-hydroxy-5-nitrobenzyl bromide or sulphenyl halides. Tyrosine residues on the other hand, may be altered by nitration with tetranitromethane to form a 3-nitrotyrosine derivative.

Modification of the imidazole ring of a histidine residue may be accomplished by alkylation with iodoacetic acid derivatives or N-carbethoxylation with diethylpyrocarbonate.

Examples of incorporating unnatural amino acids and derivatives during peptide synthesis include, but are not limited to, use of norleucine, 4-amino butyric acid, 4-amino-3-hydroxy-5-phenylpentanoic acid, 6-aminohexanoic acid, t-butylglycine, norvaline, phenylglycine, ornithine, sarcosine, 4-amino-3-hydroxy-6-methylheptanoic acid, 2-thienyl alanine and/or D-isomers of amino acids. A list of unnatural amino acid, contemplated herein is shown in Table 2.

TABLE 2
Codes for non-conventional amino acids

| Non-conventional | | Non-conventional | |
|---|---|---|---|
| amino acid | Code | amino acid | Code |
| α-aminobutyric acid | Abu | L-N-methylalanine | Nmala |
| α-amino-α-methylbutyrate | Mgabu | L-N-methylarginine | Nmarg |
| aminocyclopropane- | Cpro | L-N-methylasparagine | Nmasn |
| carboxylate | | L-N-methylaspartic acid | Nmasp |
| aminoisobutyric acid | Aib | L-N-methylcysteine | Nmcys |
| aminonorbornyl- | Norb | L-N-methylglutamine | Nmgln |
| carboxylate | | L-N-methylglutamic acid | Nmglu |
| cyclohexylalanine | Chexa | L-Nmethylhistidine | Nmhis |
| cyclopentylalanine | Cpen | L-N-methylisolleucine | Nmile |
| D-alanine | Dal | L-N-methylleucine | Nmleu |
| D-arginine | Darg | L-N-methyllysine | Nmlys |
| D-aspartic acid | Dasp | L-N-methylmethionine | Nmmet |
| D-cysteine | Dcys | L-N-methylnorleucine | Nmnle |
| D-glutamine | Dgln | L-N-methylnorvaline | Nmnva |
| D-glutamic acid | Dglu | L-N-methylornithine | Nmorn |
| D-histidine | Dhis | L-N-methylphenylalanine | Nmphe |
| D-isoleucine | Dile | L-N-methylproline | Nmpro |
| D-leucine | Dleu | L-N-methylserine | Nmser |
| D-lysine | Dlys | L-N-methylthreonine | Nmthr |
| D-methionine | Dmet | L-N-methyltryptophan | Nmtrp |
| D-ornithine | Dorn | L-N-methyltyrosine | Nmtyr |
| D-phenylalanine | Dphe | L-N-methylvaline | Nmval |
| D-proline | Dpro | L-N-methylethylglycine | Nmetg |
| D-serine | Dser | L-N-methyl-t-butylglycine | Nmtbug |
| D-threonine | Dthr | L-norleucine | Nle |
| D-tryptophan | Dtrp | L-norvaline | Nva |
| D-tyrosine | Dtyr | α-methyl-aminoisobutyrate | Maib |
| D-valine | Dval | α-methyl-γ-aminobutyrate | Mgabu |
| D-α-methylalanine | Dmala | α-methylcyclohexylalanine | Mchexa |
| D-α-methylarginine | Dmarg | α-methylcylcopentylalanine | Mcpen |
| D-α-methylasparagine | Dmasn | α-methyl-α-napthylalanine | Manap |
| D-α-methylaspartate | Dmasp | α-methylpenicillamine | Mpen |
| D-α-methylcysteine | Dmcys | N-(4-aminobutyl)glycine | Nglu |
| D-α-methylglutamine | Dmgln | N-(2-aminoethyl)glycine | Naeg |
| D-α-methylhistidine | Dmhis | N-(3-aminopropyl)glycine | Norn |
| D-α-methylisoleucine | Dmile | N-amino-α-methylbutyrate | Nmaabu |
| D-α-methylleucine | Dmleu | α-napthylalanine | Anap |
| D-α-methyllysine | Dmlys | N-benzylglycine | Nphe |
| D-α-methylmethionine | Dmmet | N-(2-carbamylethyl)glycine | Ngln |
| D-α-methylornithine | Dmorn | N-(carbamylmethyl)glycine | Nasn |
| D-α-methylphenylalanine | Dmphe | N-(2-carboxyethyl)glycine | Nglu |
| D-α-methylproline | Dmpro | N-(carboxymethyl)glycine | Nasp |
| D-α-methylserine | Dmser | N-cyclobutylglycine | Ncbut |
| D-α-methylthreonine | Dmthr | N-cycloheptylglycine | Nchep |
| D-α-methyltryptophan | Dmtrp | N-cyclohexylglycine | Nchex |
| D-α-methyltyrosine | Dmty | N-cyclodecylglycine | Ncdec |
| D-α-methylvaline | Dmval | N-cylcododecylglycine | Ncdod |
| D-N-methylalanine | Dnmala | N-cyclooctylglycine | Ncoct |
| D-N-methylarginine | Dnmarg | N-cyclopropylglycine | Ncpro |
| D-N-methylasparagine | Dnmasn | N-cycloundecylglycine | Ncund |
| D-N-methylaspartate | Dnmasp | N-(2,2-diphenylethyl)glycine | Nbhm |
| D-N-methylcysteine | Dnmcys | N-(3,3-diphenylpropyl)glycine | Nbhe |
| D-N-methylglutamine | Dnmgln | N-(3-guanidinopropyl)glycine | Narg |
| D-N-methylglutamate | Dmnglu | N-(1-hydroxyethyl)glycine | Nthr |
| D-N-methylhistidine | Dnmhis | N-(hydroxyethyl))glycine | Nser |
| D-N-methylisoleucine | Dnmile | N-(imidazolylethyl))glycine | Nhis |
| D-N-methylleucine | Dnmleu | N-(3-indolylyethyl)glycine | Nhtrp |
| D-N-methyllysine | Dnmlys | N-methyl-γ-aminobutyrate | Nmgabu |
| N-methylcyclohexylalanine | Nmchexa | D-N-methylmethionine | Dnmmet |
| D-N-methylornithine | Dnmorn | N-methylcyclopentylalanine | Nmcpen |
| N-methylglycine | Nala | D-N-methylphenylalanine | Dnmphe |
| N-methylaminoisobutyrate | Nmaib | D-N-methylproline | Dnmpro |
| N-(1-methylpropyl)glycine | Nile | D-N-methylserine | Dnmser |
| N-(2-methylpropyl)glycine | Nleu | D-N-methylthreonine | Dnmthr |
| D-N-methyltryptophan | Dnmtrp | N-(1-methylethyl)glycine | Nval |
| D-N-methyltyrosine | Dnmtyr | N-methyla-napthylalanine | Nmanap |
| D-N-methylvaline | Dnmval | N-methylpenicillamine | Nmpen |
| γ-aminobutyric acid | Gabu | N-(p-hydroxyphenyl)glycine | Nhtyr |
| L-t-butylglycine | Tbug | N-(thiomethyl)glycine | Ncys |
| L-ethylglycine | Etg | penicillamine | Pen |
| L-homophenylalanine | Hphe | L-α-methylalanine | Mala |
| L-α-methylarginine | Marg | L-α-methylasparagine | Masn |
| L-α-methylaspartate | Masp | L-α-methyl-t-butylglycine | Mtbug |
| L-α-methylcysteine | Mcys | L-methylethylglycine | Metg |
| L-α-methylglutamine | Mgln | L-α-methylglutamate | Mglu |
| L-α-methylhistidine | Mhis | L-α-methylhomophenylalanine | Mhphe |
| L-α-methylisoleucine | Mile | N-(2-methylthioethyl)glycine | Nmet |
| L-α-methylleucine | Mleu | L-α-methyllysine | Mlys |
| L-α-methylmethionine | Mmet | L-α-methylnorleucine | Mnle |
| L-α-methylnorvaline | Mnva | L-α-methylornithine | Morn |
| L-α-methylphenylalanine | Mphe | L-α-methylproline | Mpro |
| L-α-methylserine | Mser | L-α-methylthreonine | Mthr |
| L-α-methyltryptophan | Mtrp | L-α-methyltyrosine | Mtyr |
| L-α-methylvaline | Mval | L-N-methylhomophenylalanine | Nmhphe |
| N-(N-(2,2-diphenylethyl) | Nnbhm | N-(N-(3,3-diphenylpropyl) | Nnbhe |
| carbamylmethyl)glycine | | carbamylmethyl)glycine | |
| 1-carboxy-1-(2,2-diphenyl- | Nmbc | | |
| ethylamino)cyclopropane | | | |

Crosslinkers can be used, for example, to stabilize 3D conformations, using homo-bifunctional crosslinkers such as the bifunctional imido esters having (CH₂)ₙ spacer groups with n=1 to n=6, glutaraldehyde, N-hydroxysuccinimide esters and hetero-bifunctional reagents which usually contain an amino-reactive moiety such as N-hydroxysuccinimide and another group specific-reactive moiety such as maleimido or dithio moiety (SH) or carbodiimide (COOH). In addition, peptides can be conformationally constrained by, for example, incorporation of C_{α} and N_{α}-methylamino acids, introduction of double bonds between C_{α} and C_{β} atoms of amino acids and the formation of cyclic peptides or analogs by introducing covalent bonds such as forming an amide bond between the N and C termini, between two side chains or between a side chain and the N or C terminus.

Accordingly, one aspect of the present invention contemplates any compound which binds or otherwise interacts with a target gene or expression product thereof resulting in the mitigation, inhibition or general down-regulation or up-regulation of the level of expression of a target gene or the activity of a gene expression product.

One particularly useful group of aP2 inhibitors is a heterocyclic containing biphenyl compound such as the compound in Formula I: 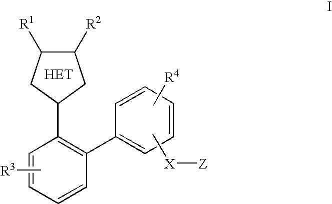
where:
R¹ and R² are the same or different and are independently selected from H, alkyl, cycloalkyl, cycloalkenyl, aryl, heteroaryl, heteroarylalkyl, aralkyl, cycloheteroalkyl and cycloheteroalkylalkyl;
R³ is selected from hydrogen, halogen, alkyl, alkenyl, alkynyl, alkoxy, cycloalkyl, cycloalkylalkyl, cycloalkenyl, alkylcarbonyl, cycloheteroalkyl, cyclohetercalkylalkyl, cycloalkenylalkyl, haloalkyl, polyhaloalkyl, cyano, nitro, hydroxy, amino, alkanoyl, alkylthic, alkylsulfonyl, alkoxycarbonyl, alkylaminocarbonyl, alkylcarbonylamino, alkylcarbonyloxy, alkylaminesulfonyl, alkylamino, dialkylamino, all optionally substituted through available carbon atoms with 1, 2, 3, 4 or S groups selected from hydrogen, halo, alkyl, polyhaloalkyl, alkoxy, haloalkoxy, polyhaloalkoxy, alkoxycarbonyl, alkenyl, alkynyl, cycloalkyl, cycloalkylalkyl, cycloheteroalkyl, cycloheteroalkylalkyl, hydroxy, hydroxyalkyl, nitro, cyano, amino, substituted amino, alkylamino, dialkylamino, thiol, alkylthio, alkylcarbonyl, acyl, alkoxycarbonyl, aminocarbonyl, alkynylaminocarbonyl, alkylaminocarbonyl, alkenylaminocarbonyl, alkylcarbonyloxy, alkylcarbonylamino, alkoxycarbonylaminc, alkylsulfonyl, aminosulfinyl, aminosulfinyl, alkylsulfinyl, sulfonamido or sulfonyl;
R⁴ is selected from hydrogen, halogen, alkyl, alkenyl, alkynyl, alkoxy, aryl, heteroaryl, arylalkyl, heteroarylalkyl, arylalkenyl, arylalkynyl, cycloalkyl, cycloalkylalkyl, polycycloalkyl, polycycloalkylalkyl, cycloalkenyl, cycloalkynyl, alkylcarbonyl, arylcarbonyl, cycloheteroalkyl, cycloheteroalkylalkyl, cycloalkenylalkyl, polycycloalkenyl, polycycloalkenylalkyl, polycycloalkynyl, polycycloalkynylalkyl, haloalkyl, polyhaloalkyl, cyano, nitro, hydroxy, amino, alkanoyl, aroyl, alkylthio, alkylsulfonyl, arylsulfonyl, alkoxycarbonyl, aryloxycarbonyl, alkylaminocarbonyl, arylaminocarbonyl, alkylcarbonylamino, alkylcarbonyloxy, alkylaminosulfonyl, arylaminosulfonyl, alkylamino, dialkylamino, all optionally substituted through available carbon atoms with 1, 2, 3, 4 or S groups selected from hydrogen, halo, alkyl, halcalkyl, polyhaloalkyl, alkoxy, haloalkoxy, polyhaloalkoxy, alkoxycarbonyl, alkenyl, alkynyl, cycloalkyl, cycloalkylalkyl, cycloheteroalkyl, cycloheteroalkylalkyl, aryl, heteroaryl, arylalkyl, arylcycloalkyl, arylalkenyl, arylalkynyl, aryloxy, aryloxyalkyl, arylalkoxy, arylazo, heteroaryloxc, heteroarylalkyl, heteroarylalkenyl, heteroaryloxy, hydroxy, hydroxyalkyl, nitro, cyano, amino, substituted amino, alkylamino, dialkylamino, thiol, alkylthio, arylthio, heteroarylthio, arylthioalkyl, alkylcarbonyl, arylcarbonyl, acyl, arylaminocarbonyl, alkoxycarbonyl, aminocarbonyl, alkynylaminocarbonyl, alkylaminocarbonyl, alkenylaminocarbonyl, alkylcarbonyloxy, arylcarbonyloxy, alkylcarbonylamino, arylcarbonylamino, alkoxycarbonylamino, arylsulfinyl, arylsulfinylalkyl, arylsulfonyl, alkylsulfonyl, aminosulfinyl, aminosulfonyl, arylsulfonylamino, heteroarylcarbonylamino, heteroarylsulfinyl, heteroarylthio, heteroarylsulfonyl, alkylsulfonyl, sulfonamido or sulfonyl;
X is a bond or a linker group selected from (CH₂)ₙ, O(CH₂)ₙ, S(CH₂)ₙ, NHCO, CH═CH, cycloalkylene or N(R⁵)(CH₂)ₙ, (where n=0-5 and R⁵ is H, alkyl, or alkanoyl);
Z is CO₂H or tetrazole of the formula 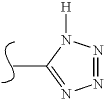
or its tautomer; and the group 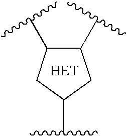
represents a heterocyclic group (including heteroaryl and cycloheteroalkyl groups) preferably containing 5-members within the ring and containing preferably 1-3 heteroatoms within the ring, and which may further optionally include one or two substituents which are alkyl, alkenyl, hydroxyalkyl, keto, carboxyalkyl, carboxy, cycloalkyl, alkoxy, formyl, alkanoyl, alkoxyalkyl or alkoxycarboxyl;
with the provisos that:
(1) n≠o when Z is CO₂H and X is O(CH₂)ₙ, S(CH₂)ₙ or N(R⁵)(CH₂)ₙ); and
(2) when 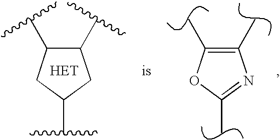
then X-Z may not be O-lower alkylene-CO₂H or —O-lower alkylene-CO₂alkyl when R¹ and R² are both aryl or substituted aryl and R³ and R⁴ are each hydrogen;
and including pharmaceutically acceptable salts thereof, and prodrug esters thereof, and all stereoisomers thereof.

Examples of the group 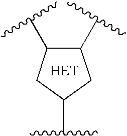
include (but are not limited to) heteroaryl groups and cyclohetercalkyl groups as defined herein and preferably include the following: 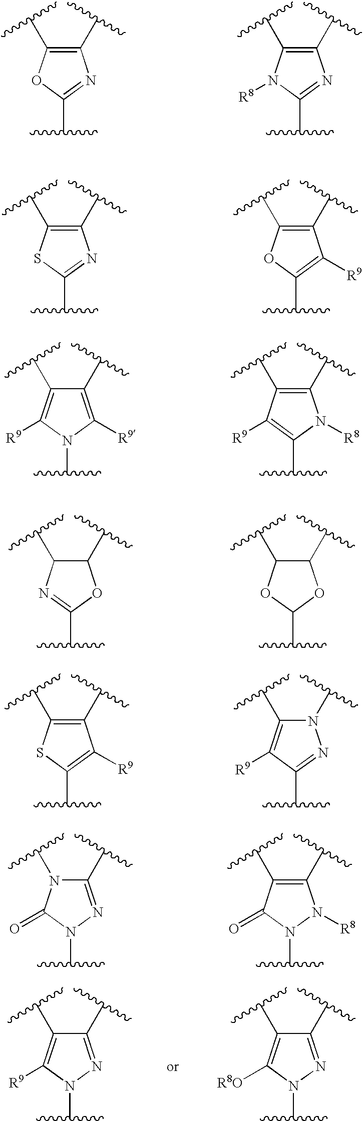
where:
R⁸ is selected from H, alkyl, haloalkyl, hydroxyalkyl, alkoxyalkyl, or alkenyl, and
R⁹ and R⁹ are the same or different and are selected independently from H, alkyl, alkoxy, alkenyl, formyl, CO₂H, CO₂ (lower alkyl), hydroxyalkyl, alkoxyalkyl, CO(alkyl), carboxylalkyl, haloalkyl, alkenyl or cycloalkyl.

With respect to the R⁸, R⁹ and R^{9′} groups, alkyl by itself or as part of another group will preferably contain 1 to 6 carbons.

Examples of X-Z moieties include (but are not limited to)

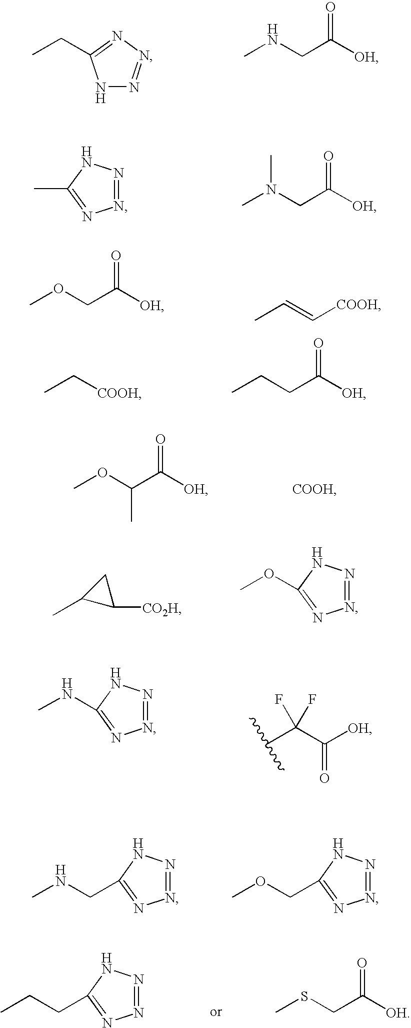

Preferred are compounds of Formula I where:— 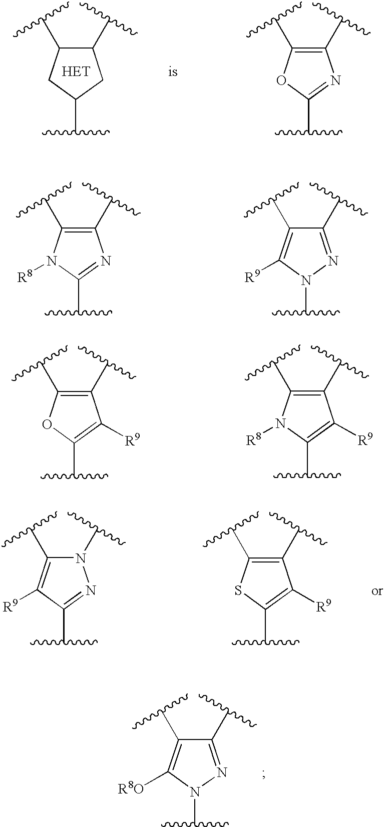
(where R⁸ is hydrogen, alkyl, fluoroalkyl or alkoxyalkyl, and where R⁹ is hydrogen, alkyl, fluoroalkyl, alkoxy or hydroxyalkyl).
R¹ and R² are each phenyl, substituted phenyl or cycloalkyl;
R³ and R⁴ are the same or different are independently selected from H, halo, alkyl or alkoxy; X is OCH₂, NHCH₂, CH₂ or CH₂CH₂; and
Z is CO₂H or tetrazole.

More preferred are compounds of Formula I where:— 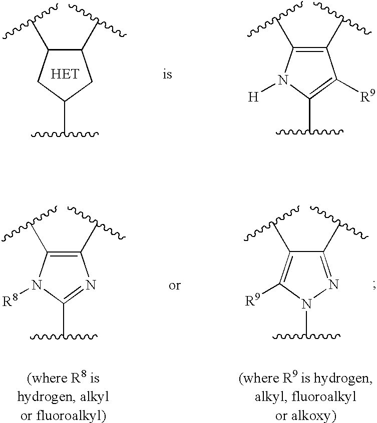
R¹ and R² are each phenyl;
R³ and R⁴ are each H; X is OCH₂, CH₂ or NHCH₂; and
Z is CO₂H or tetrazole.

Suitable compounds may be synthesized according to methods described in International Patent Application No. PCT/US00/07417 (WO 00/59506).

The present invention is also useful for screening for other compounds which reduce expression of a target gene and, in particular, an aP2 or FABP-5 gene or which inhibit the activity of a target gene product. Such targets may be used in any of a variety of drug screening techniques, such as those described herein and in International Publication No. WO 97/02048.

In some circumstances, it may be desirable to, in addition or in lieu thereof, potentiate, activate or generally up-regulate the level of expression and/or activity of expression product of a target gene. A composition comprising two or more active agents, which effect the modulation of the level of expression of a target gene or the activity of its expression product, including up- or down-regulation of the expression level or the activity of an expression product, are therefore encompassed within the scope of the present invention.

A target antagonist or agonist includes a variant of the target molecule. In one embodiment, the target is a polypeptide. The term “polypeptide” refers to a polymer of amino acids and its equivalent and does not refer to a specific length of the product, thus, peptides, oligopeptides and proteins are included within the definition of a polypeptide. This term also does not exclude modifications of the polypeptide, for example, glycosylations, acetylations, phosphorylations and the like. Included within the definition are, for example, polypeptides containing one or more analogs of an amino acid (including, for example, unnatural amino acids such as those given in Table 2) or polypeptides with substituted linkages. Such polypeptides may need to be able to enter the cell.

Another useful group of compounds is a mimetic. The terms “peptide mimetic”, “target mimetic” or “mimetic” are intended to refer to a substance which has some chemical similarity to the target but which antagonises or agonises or mimics the target. A peptide mimetic may be a peptide-containing molecule that mimics elements of protein secondary structure (Johnson et al., “Peptide Turn Mimetics” in Biotechnology and Pharmacy, Pezzuto et al., Eds., Chapman and Hall, New York, 1993). The underlying rationale behind the use of peptide mimetics is that the peptide backbone of proteins exists chiefly to orient amino acid side chains in such a way as to facilitate molecular interactions such as those of antibody and antigen, enzyme and substrate or scaffolding proteins. A peptide mimetic is designed to permit molecular interactions similar to the natural molecule. Peptide or non-peptide mimetics may be useful, for example, to inhibit either the level of expression of a target gene or the activity of a gene expression product and, in particular an aP2 or FABP-5 gene or expression product.

Again, the compounds of the present invention may be selected to interact with a target alone, or single or multiple compounds may be used to affect multiple targets. For example, multiple genes may be targeted to modulate, independently, their respective levels of expression and/or the activity of one or more expression products, thereby beneficially affecting the instigation and/or progression of an undesirable inflammatory response such as occurs in asthma.

The target polypeptide or fragment employed in such a test may either be free in solution, affixed to a solid support, or borne on a cell surface. One method of drug screening utilizes eukaryotic or prokaryotic host cells which are stably transformed with recombinant polynucleotides expressing the polypeptide or fragment, preferably in competitive binding assays. Such cells, either in viable or fixed form, can be used for standard binding assays. One may measure, for example, the formation of complexes between a target or fragment and the agent being tested, or examine the degree to which the formation of a complex between a target or fragment and a known ligand is aided or interfered with by the agent being tested.

A substance identified as a modulator of gene target expression or expression product activity may be a peptide or non-peptide in nature. Non-peptide “small molecules” are often preferred for many in vivo pharmaceutical uses. Accordingly, a mimetic or mimic of the substance (particularly if a peptide) may be designed for pharmaceutical use.

The designing of mimetics to a pharmaceutically active compound is a known approach to the development of pharmaceuticals based on a “lead” compound. This might be desirable where the active compound is difficult or expensive to synthesize or where it is unsuitable for a particular method of administration, e.g. peptides are unsuitable active agents for oral compositions as they tend to be quickly degraded by proteases in the alimentary canal. Mimetic design, synthesis and testing are generally used to avoid randomly screening large numbers of molecules for a desired property. Conveniently, and in one example, the mimetic is of an expression product of a target gene such as, for example, a aP2 or FABP-5 gene product.

There are several steps commonly taken in the design of a mimetic from a compound having a given desired property. First, the particular parts of the compound that are critical and/or important in determining the desired property are determined. In the case of a peptide, this can be done by systematically varying the amino acid residues in the peptide, e.g. by substituting each residue in turn. Alanine scans of peptides are commonly used to refine such peptide motifs. These parts or residues constituting the active region of the compound are known as its “pharmacophore”.

Once the pharmacophore has been found, its structure is modeled according to its physical properties, e.g. stereochemistry, bonding, size and/or charge, using data from a range of sources, e.g. spectroscopic techniques, x-ray diffraction data and NMR. Computational analysis, similarity mapping (which models the charge and/or volume of a pharmacophore, rather than the bonding between atoms) and other techniques can be used in this modeling process.

In a variant of this approach, the three-dimensional structure of the ligand and its binding partner are modeled. This can be especially useful where the ligand and/or binding partner change conformation on binding, allowing the model to take account of this in the design of the mimetic. Modeling can be used to generate inhibitors which interact with the linear sequence or a three-dimensional configuration.

A template molecule is then selected onto which chemical groups which mimic the pharmacophore can be grafted. The template molecule and the chemical groups grafted onto it can conveniently be selected so that the mimetic is easy to synthesize, is likely to be pharmacologically acceptable, and does not degrade in vivo, while retaining the biological activity of the lead compound. Alternatively, where the mimetic is peptide-based, further stability can be achieved by cyclizing the peptide, increasing its rigidity. The mimetic or mimetics found by this approach can then be screened to see whether they have the target property, or to what extent they exhibit it. Further optimization or modification can then be carried out to arrive at one or more final mimetics for in vivo or clinical testing.

The goal of rational drug design is to produce structural analogs of biologically active polypeptides of interest or of small molecules with which they interact (e.g. agonists, antagonists, inhibitors or enhancers) in order to fashion drugs which are, for example, more active or stable forms of the polypeptide, or which, e.g. enhance or interfere with the function of a polypeptide in vivo. See, e.g. Hodgson (Bio/Technology 9: 19-21, 1991). In one approach, one first determines the three-dimensional structure of a protein of interest (e.g. an expression product of a target gene such as, for example, aP2 or FABP-5) by x-ray crystallography, by computer modeling or most typically, by a combination of approaches. Useful information regarding the structure of a polypeptide may also be gained by modeling based on the structure of homologous proteins. An example of rational drug design is the development of HIV protease inhibitors (Erickson et al., Science 249: 527-533, 1990). In addition, target molecules may be analyzed by an alanine scan (Wells, Methods Enzymol. 202: 2699-2705, 1991). In this technique, an amino acid residue is replaced by Ala and its effect on the peptide's activity is determined. Each of the amino acid residues of the peptide is analyzed in this manner to determine the important regions of the peptide.

It is also possible to isolate a target-specific antibody, selected by a functional assay and then to solve its crystal structure. In principle, this approach yields a pharmacore upon which subsequent drug design can be based. It is possible to bypass protein crystallography altogether by generating anti-idiotypic antibodies (anti-ids) to a functional, pharmacologically active antibody. As a mirror image of a mirror image, the binding site of the anti-ids would be expected to be an analog of the original receptor. The anti-id could then be used to identify and isolate peptides from banks of chemically or biologically produced banks of peptides. Selected peptides would then act as the pharmacore.

Two-hybrid screening is also useful in identifying other members of a biochemical or genetic pathway associated with a target. Two-hybrid screening conveniently uses Saccharomyces cerevisiae and Saccharomyces pombe. Target interactions and screens for inhibitors can be carried out using the yeast two-hybrid system, which takes advantage of transcriptional factors that are composed of two physically separable, functional domains. The most commonly used is the yeast GAL4 transcriptional activator consisting of a DNA binding domain and a transcriptional activation domain. Two different cloning vectors are used to generate separate fusions of the GAL4 domains to genes encoding potential binding proteins. The fusion proteins are co-expressed, targeted to the nucleus and if interactions occur, activation of a reporter gene (e.g. lacZ) produces a detectable phenotype. In the present case, for example, S. cerevisiae is co-transformed with a library or vector expressing a cDNA GAL4 activation domain fusion, and a vector expressing a target gene such as, for example, an aP2 or FABP-5 gene fused to GAL4. If lacZ is used as the reporter gene, co-expression of the fusion proteins will produce a blue color. Small molecules or other candidate compounds which interact with a target will result in loss of color of the cells. Reference may be made to the yeast two-hybrid systems as disclosed by Munder et al. (Appl. Microbiol. Biotechnol. 52(3): 311-320, 1999) and Young et al., Nat. Biotechnol. 16(10): 946-950, 1998). Molecules thus identified by this system are then re-tested in animal cells.

The present invention extends to a genetic approach to down-regulating expression of a target gene such as, for example, aP2 or FABP-5, and/or down-regulating an inhibitor of a target gene or gene expression product. In one example, nucleic acid molecules that induce temporary or permanent silencing of the target gene may be used to reduce levels of the expression product. Alternatively, nucleic acid molecules, which elevate levels of an inhibitor of the expression product of the target gene, may also be used.

The terms “nucleic acids”, “nucleotide” and “polynucleotide” include RNA, cDNA, genomic DNA, synthetic forms and mixed polymers, both sense and antisense strands, and may be chemically or biochemically modified or may contain non-natural or derivatized nucleotide bases, as will be readily appreciated by those skilled in the art. Such modifications include, for example, labels, methylation, substitution of one or more of the naturally occurring nucleotides with an analog (such as the morpholine ring), internucleotide modifications such as uncharged linkages (e.g. methyl phosphonates, phosphotriesters, phosphoamidates, carbamates, etc.), charged linkages (e.g. phosphorothioates, phosphorodithioates, etc.), pendent moieties (e.g. polypeptides), intercalators (e.g. acridine, psoralen, etc.), chelators, alkylators and modified linkages (e.g. α-anomeric nucleic acids, etc.). Also included are synthetic molecules that mimic polynucleotides in their ability to bind to a designated sequence via hydrogen binding and other chemical interactions. Such molecules are known in the art and include, for example, those in which peptide linkages substitute for phosphate linkages in the backbone of the molecule.

Antisense polynucleotide sequences, for example, are useful in silencing transcripts of target genes such as, for example, aP2 and FABP-5. Furthermore, polynucleotide vectors containing all or a portion of a gene locus encoding an inhibitor of the expression product of a target gene may be placed under the control of a promoter in an antisense orientation and introduced into a cell. Expression of such an antisense construct within a cell will interfere with target transcription and/or translation. Furthermore, co-suppression and mechanisms to induce RNAi or siRNA may also be employed. Alternatively, antisense or sense molecules may be directly administered. In this latter embodiment, the antisense or sense molecules may be formulated in a composition and then administered by any number of means to target cells.

A variation on antisense and sense molecules involves the use of morpholinos, which are oligonucleotides composed of morpholine nucleotide derivatives and phosphorodiamidate linkages (for example, Summerton and Weller, Antisense and Nucleic Acid Drug Development 7: 187-195, 1997). Such compounds are injected into embryos and the effect of interference with mRNA is observed.

In one embodiment, the present invention employs compounds such as oligonucleotides and similar species for use in modulating the function or effect of nucleic acid molecules up-regulated during an inflammatory condition such as asthma, i.e. the oligonucleotides induce pre-transcriptional or post-transcriptional gene silencing. This is accomplished by providing oligonucleotides which specifically hybridize with one or more nucleic acid molecules encoding the inhibitor. The oligonucleotides may be provided directly to a cell or generated within the cell. As used herein, the term “target nucleic acid” is used for convenience to encompass DNA encoding the inhibitor, RNA (including pre-mRNA and mRNA or portions thereof) transcribed from such DNA, and also cDNA derived from such RNA. The hybridization of a compound of the subject invention with its target nucleic acid is generally referred to as “antisense”. Consequently, the preferred mechanism believed to be included in the practice of some preferred embodiments of the invention is referred to herein as “antisense inhibition.” Such antisense inhibition is typically based upon hydrogen bonding-based hybridization of oligonucleotide strands or segments such that at least one strand or segment is cleaved, degraded, or otherwise rendered inoperable. In this regard, it is presently preferred to target specific nucleic acid molecules and their functions for such antisense inhibition.

The functions of DNA to be interfered with can include replication and transcription. Replication and transcription, for example, can be from an endogenous cellular template, a vector, a plasmid construct or otherwise. The functions of RNA to be interfered with can include functions such as translocation of the RNA to a site of protein translation, translocation of the RNA to sites within the cell which are distant from the site of RNA synthesis, translation of protein from the RNA, splicing of the RNA to yield one or more RNA species, and catalytic activity or complex formation involving the RNA which may be engaged in or facilitated by the RNA. In one example, the result of such interference with target nucleic acid function is reduced expression levels of the target gene itself or of a gene which inhibits or potentiates target gene expression or activity of a gene product. In the context of the present invention, “modulation” and “modulation of expression” mean either an increase (stimulation) or a decrease (inhibition) in the amount or levels of a nucleic acid molecule encoding the gene, e.g., DNA or RNA. Inhibition is often the preferred form of modulation of expression and mRNA is often a preferred target nucleic acid.

In the context of this invention, “hybridization” means the pairing of complementary strands of oligomeric compounds. In the present invention, the preferred mechanism of pairing involves hydrogen bonding, which may be Watson-Crick, Hoogsteen or reversed Hoogsteen hydrogen bonding, between complementary nucleoside or nucleotide bases (nucleobases) of the strands of oligomeric compounds. For example, adenine and thymine are complementary nucleobases which pair through the formation of hydrogen bonds. Hybridization can occur under varying circumstances.

An antisense compound is specifically hybridizable when binding of the compound to the target nucleic acid interferes with the normal function of the target nucleic acid to cause a loss of activity, and there is a sufficient degree of complementarity to avoid non-specific binding of the antisense compound to non-target nucleic acid sequences under conditions in which specific binding is desired, i.e. under physiological conditions in the case of in vivo assays or therapeutic treatment, and under conditions in which assays are performed in the case of in vitro assays.

“Complementary” as used herein, refers to the capacity for precise pairing between two nucleobases of an oligomeric compound. For example, if a nucleobase at a certain position of an oligonucleotide (an oligomeric compound), is capable of hydrogen bonding with a nucleobase at a certain position of a target nucleic acid, said target nucleic acid being a DNA, RNA, or oligonucleotide molecule, then the position of hydrogen bonding between the oligonucleotide and the target nucleic acid is considered to be a complementary position. The oligonucleotide and the further DNA, RNA, or oligonucleotide molecule are complementary to each other when a sufficient number of complementary positions in each molecule are occupied by nucleobases which can hydrogen bond with each other. Thus, “specifically hybridizable” and “complementary” are terms which are used to indicate a sufficient degree of precise pairing or complementarity over a sufficient number of nucleobases such that stable and specific binding occurs between the oligonucleotide and a target nucleic acid.

According to the present invention, compounds include antisense oligomeric compounds, antisense oligonucleotides, ribozymes, external guide sequence (EGS) oligonucleotides, alternate splicers, primers, probes, and other oligomeric compounds which hybridize to at least a portion of the target nucleic acid. As such, these compounds may be introduced in the form of single-stranded, double-stranded, circular or hairpin oligomeric compounds and may contain structural elements such as internal or terminal bulges or loops. Once introduced to a system, the compounds of the invention may elicit the action of one or more enzymes or structural proteins to effect modification of the target nucleic acid. One non-limiting example of such an enzyme is RNAse H, a cellular endonuclease which cleaves the RNA strand of an RNA:DNA duplex. It is known in the art that single-stranded antisense compounds which are “DNA-like” elicit RNAse H. Activation of RNase H, therefore, results in cleavage of the RNA target, thereby greatly enhancing the efficiency of oligonucleotide-mediated inhibition of gene expression. Similar roles have been postulated for other ribonucleases such as those in the RNase III and ribonuclease L family of enzymes.

While the preferred form of antisense compound is a single-stranded antisense oligonucleotide, in many species the introduction of double-stranded structures, such as double-stranded RNA (dsRNA) molecules, has been shown to induce potent and specific antisense-mediated reduction of the function of a gene or its associated gene products. This phenomenon occurs in both plants and animals.

In the context of the subject invention, the term “oligomeric compound” refers to a polymer or oligomer comprising a plurality of monomeric units. In the context of this invention, the term “oligonucleotide” refers to an oligomer or polymer of ribonucleic acid (RNA) or deoxyribonucleic acid (DNA) or mimetics, chimeras, analogs and homologs thereof. This term includes oligonucleotides composed of naturally occurring nucleobases, sugars and covalent internucleoside (backbone) linkages as well as oligonucleotides having non-naturally occurring portions which function similarly. Such modified or substituted oligonucleotides are often preferred over native forms because of desirable properties such as, for example, enhanced cellular uptake, enhanced affinity for a target nucleic acid and increased stability in the presence of nucleases.

While oligonucleotides are a preferred form of the compounds of this invention, the present invention comprehends other families of compounds as well, including but not limited to oligonucleotide analogs and mimetics such as those herein described.

The open reading frame (ORF) or “coding region” which is known in the art to refer to the region between the translation initiation codon and the translation termination codon, is a region which may be effectively targeted. Within the context of the present invention, one region is the intragenic region encompassing the translation initiation or termination codon of the open reading frame (ORF) of a gene.

Other target regions include the 5′ untranslated region (5′UTR), known in the art to refer to the portion of an mRNA in the 5′ direction from the translation initiation codon, and thus including nucleotides between the 5′ cap site and the translation initiation codon of an mRNA (or corresponding nucleotides on the gene), and the 3′ untranslated region (3′UTR), known in the art to refer to the portion of an mRNA in the 3′ direction from the translation termination codon, and thus including nucleotides between the translation termination codon and 3′ end of an mRNA (or corresponding nucleotides on the gene). The 5′ cap site of an mRNA comprises an N7-methylated guanosine residue joined to the 5′-most residue of the mRNA via a 5′-5′ triphosphate linkage. The 5′ cap region of an mRNA is considered to include the 5′ cap structure itself as well as the first 50 nucleotides adjacent to the cap site. It is also preferred to target the 5′ cap region.

Although some eukaryotic mRNA transcripts are directly translated, many contain one or more regions, known as “introns”, which are excised from a transcript before it is translated. The remaining (and, therefore, translated) regions are known as “exons” and are spliced together to form a continuous mRNA sequence. Targeting splice sites, i.e. intron-exon junctions or exon-intron junctions, may also be particularly useful in situations where aberrant splicing is implicated in disease, or where an overproduction of a particular splice product is implicated in disease. Aberrant fusion junctions due to rearrangements or deletions are also preferred target sites. mRNA transcripts produced via the process of splicing of two (or more) mRNAs from different gene sources are known as “fusion transcripts”. It is also known that introns can be effectively targeted using antisense compounds targeted to, for example, DNA or pre-mRNA.

As is known in the art, a nucleoside is a base-sugar combination. The base portion of the nucleoside is normally a heterocyclic base. The two most common classes of such heterocyclic bases are the purines and the pyrimidines. Nucleotides are nucleosides that further include a phosphate group covalently linked to the sugar portion of the nucleoside. For those nucleosides that include a pentofuranosyl sugar, the phosphate group can be linked to either the 2′, 3′ or 5′ hydroxyl moiety of the sugar. In forming oligonucleotides, the phosphate groups covalently link adjacent nucleosides to one another to form a linear polymeric compound. In turn, the respective ends of this linear polymeric compound can be further joined to form a circular compound, however, linear compounds are generally preferred. In addition, linear compounds may have internal nucleobase complementarity and may, therefore, fold in a manner as to produce a fully or partially double-stranded compound. Within oligonucleotides, the phosphate groups are commonly referred to as forming the internucleoside backbone of the oligonucleotide. The normal linkage or backbone of RNA and DNA is a 3′ to 5′ phosphodiester linkage.

Specific examples of preferred antisense compounds useful in this invention include oligonucleotides containing modified backbones or non-natural internucleoside linkages. As defined in this specification, oligonucleotides having modified backbones include those that retain a phosphorus atom in the backbone and those that do not have a phosphorus atom in the backbone. For the purposes of this specification, and as sometimes referenced in the art, modified oligonucleotides that do not have a phosphorus atom in their internucleoside backbone can also be considered to be oligonucleosides.

Preferred modified oligonucleotide backbones containing a phosphorus atom therein include, for example, phosphorothioates, chiral phosphorothioates, phosphorodithioates, phosphotriesters, aminoalkylphosphotriesters, methyl and other alkyl phosphonates including 3′-alkylene phosphonates, 5′-alkylene phosphonates and chiral phosphonates, phosphinates, phosphoramidates including 3′-amino phosphoramidate and aminoalkylphosphoramidates, thionophosphoramidates, thionoalkylphosphonates, thionoalkylphosphotriesters, selenophosphates and boranophosphates having normal 3′-5′ linkages, 2′-5′ linked analogs of these, and those having inverted polarity wherein one or more internucleotide linkages is a 3′ to 3′, 5′ to 5′ or 2′ to 2′ linkage. Preferred oligonucleotides having inverted polarity comprise a single 3′ to 3′ linkage at the 3′-most internucleotide linkage i.e. a single inverted nucleoside residue which may be abasic (the nucleobase is missing or has a hydroxyl group in place thereof). Various salts, mixed salts and free acid forms are also included.

Antisense oligonucleotides are particularly useful in the treatment of inflammatory conditions of the nasal and bronchial passages. The antisense oligonucleotides may be directed at one or more target genes. These can also be topically applied, generally in a cream-based composition or more preferably is an inhalant or powdered spray such as with fine dry or wet microparticles.

In an alternative embodiment, genetic constructs including DNA vaccines are used to generate antisense molecules in vivo. Furthermore, many of the preferred features described above are appropriate for sense nucleic acid molecules or for gene therapy applications to down-regulate a target gene the expression of which is associated with the increased likelihood of an undesirable inflammatory asthma response. Inhalant compositions are particularly useful in the treatment of inflammatory conditions.

Following identification of an agent which modulates the level of expression of a target gene or the activity of a gene expression product, it may be manufactured and/or used in a preparation, i.e. in the manufacture or formulation or a composition such as a medicament, pharmaceutical composition or drug. These may be administered to individuals in a method of treatment or prophylaxis. Alternatively, they may be incorporated into a patch or slow release capsule or implant or incorporated into a microparticle, inhalant spray or otherwise suitable medium.

Thus, the present invention extends, therefore, to a pharmaceutical composition, medicament, drug or other composition including a patch or slow release formulation or inhalant formulation comprising an agonist or antagonist of target activity or gene expression. Another aspect of the present invention contemplates a method comprising administration of such a composition to a patient such as for treatment or prophylaxis of an inflammatory condition. Furthermore, the present invention contemplates a method of making a pharmaceutical composition comprising admixing a compound of the instant invention with a pharmaceutically acceptable excipient, vehicle or carrier, and optionally other ingredients. Where multiple compositions are provided, then such compositions may be given simultaneously or sequentially. Sequential administration includes administration within nanoseconds, seconds, minutes, hours or days. Preferably, within seconds or minutes.

Two- or multi-part pharmaceutical compositions or packs are also contemplated with multiple components, such as comprising those which down-regulate or up-regulate the level of expression of a target gene or the activity of its expression product and, in addition, another such component. Alternatively a multiple component-composition may comprise, in addition, an agent which down-regulates or up-regulates the level of expression of a second target gene, or the activity of the expression product of the second-mentioned gene. Such multi-part pharmaceutical compositions or packs maintain different agents or groups of agents separately. These are either dispensed separately or admixed prior to being dispensed.

Accordingly, another aspect of the present invention contemplates a method for the treatment or prophylaxis of an inflammatory condition in an animal, said method comprising administering to said animal an effective amount of a compound as described herein or a composition comprising same. Two or more targets may be selected for up- or down-regulation. For example, it might be desired to target a P2 and FABP-5.

The term “administering to” includes the inhalant or nasal application of a composition.

Preferably, the animal is a mammal such as a human or laboratory test animal such as a mouse, rat, rabbit, guinea pig, hamster, zebrafish or amphibian. Most preferably, the mammal is a human

This method also includes providing a wild-type or mutant target gene function to a cell. This is particularly useful when generating an animal model. Alternatively, it may be part of a gene therapy approach. This may be particularly useful when an infant or fetus comes from one or more parents which are likely to pass on the genetic predisposition of, for example, asthma. A target gene or a part of the gene may be introduced into the cell in a vector such that the gene remains extrachromosomal. In such a situation, the gene will be expressed by the cell from the extrachromosomal location. If a gene portion is introduced and expressed in a cell carrying a mutant target allele, the gene portion should encode a part of the target protein. Vectors for introduction of genes both for recombination and for extrachromosomal maintenance are known in the art and any suitable vector may be used. Methods for introducing DNA into cells such as electroporation calcium phosphate co-precipitation and viral transduction are known in the art.

Gene transfer systems known in the art may be useful in the practice of genetic manipulation. These include viral and non-viral transfer methods. A number of viruses have been used as gene transfer vectors or as the basis for preparing gene transfer vectors, including papovaviruses (e.g. SV40, Madzak et al., J. Gen. Virol. 73: 1533-1536, 1992), adenovirus (Berkner, Curr. Top. Microbiol. Immunol. 158: 39-66, 1992; Berkner et al., BioTechniques 6; 616-629, 1988; Gorziglia and Kapikian, J. Virol. 66: 4407-4412, 1992; Quantin et al., Proc. Natl. Acad. Sci. USA 89: 2581-2584, 1992; Rosenfeld et al., Cell 68: 143-155, 1992; Wilkinson et al., Nucleic Acids Res. 20: 2233-2239, 1992; Stratford-Perricaudet et al., Hum. Gene Ther. 1: 241-256, 1990; Schneider et al., Nature Genetics 18: 180-183, 1998), vaccinia virus (Moss, Curr. Top. Microbiol. Immunol. 158: 25-38, 1992; Moss, Proc. Natl. Acad. Sci. USA 93: 11341-11348, 1996), adeno-associated virus (Muzyczka, Curr. Top. Microbiol. Immunol. 158: 97-129, 1992; Ohi et al., Gene 89: 279-282, 1990; Russell and Hirata, Nature Genetics 18: 323-328, 1998), herpesviruses including HSV and EBV (Margolskee, Curr. Top., Microbiol. Immunol. 158: 67-95, 1992; Johnson et al., J. Virol. 66: 2952-2965, 1992; Fink et al., Hum. Gene Ther. 3: 11-19, 1992; Breakefield and Geller, Mol. Neurobiol. 1: 339-371, 1987; Freese et al., Biochem. Pharmacol. 40: 2189-2199, 1990; Fink et al., Ann. Rev. Neurosci. 19: 265-287, 1996), lentiviruses (Naldini et al., Science 272: 263-267, 1996), Sindbis and Semliki Forest virus (Berglund et al., Biotechnology 11: 916-920, 1993) and retroviruses of avian (Bandyopadhyay and Temin, Mol. Cell. Biol. 4: 749-754, 1984; Petropoulos et al., J. Viol. 66: 3391-3397, 1992], murine [Miller, Curr. Top. Microbiol. Immunol. 158: 1-24, 1992; Miller et al., Mol. Cell. Biol. 5: 431-437, 1985; Sorge et al., Mol. Cell. Biol. 4: 1730-1737, 1984; and Baltimore, J. Virol. 54: 401-407, 1985; Miller et al., J. Virol. 62: 4337-4345, 1988] and human [Shimada et al., J. Clin. Invest. 88: 1043-1047, 1991; Helseth et al., J. Virol. 64: 2416-2420, 1990; Page et al., J. Virol. 64: 5270-5276, 1990; Buchschacher and Panganiban, J. Virol. 66: 2731-2739, 1982] origin.

Non-viral gene transfer methods are known in the art such as chemical techniques including calcium phosphate co-precipitation, mechanical techniques, for example, microinjection, membrane fusion-mediated transfer via liposomes and direct DNA uptake and receptor-mediated DNA transfer. Viral-mediated gene transfer can be combined with direct in vivo gene transfer using liposome delivery, allowing one to direct the viral vectors to particular cells. Alternatively, the retroviral vector producer cell line can be injected into particular tissue. Injection of producer cells would then provide a continuous source of vector particles.

In an approach which combines biological and physical gene transfer methods, plasmid DNA of any size is combined with a polylysine-conjugated antibody specific to the adenovirus hexon protein and the resulting complex is bound to an adenovirus vector. The trimolecular complex is then used to infect cells. The adenovirus vector permits efficient binding, internalization and degradation of the endosome before the coupled DNA is damaged. For other techniques for the delivery of adenovirus based vectors, see U.S. Pat. No. 5,691,198.

Liposome/DNA complexes have been shown to be capable of mediating direct in vivo gene transfer. While in standard liposome preparations the gene transfer process is non-specific, localized in vivo uptake and expression have been reported in tumor deposits, for example, following direct in situ administration.

If the polynucleotide encodes a sense or antisense polynucleotide or a ribozyme or DNAzyme, expression will produce the sense or antisense polynucleotide or ribozyme or DNAzyme. Thus, in this context, expression does not require that a protein product be synthesized. In addition to the polynucleotide cloned into the expression vector, the vector also contains a promoter functional in eukaryotic cells. The cloned polynucleotide sequence is under control of this promoter. Suitable eukaryotic promoters include those described above. The expression vector may also include sequences, such as selectable markers and other sequences described herein.

Cells and animals which carry mutant target alleles (e.g. aP2 or FABP-5) or where one or both alleles are deleted can be used as model systems to study the effects of modulating the expression of these genes, and/or the activity of their expression products, on inflammation. Mice, rats, rabbits, guinea pigs, hamsters, zebrafish and amphibians are particularly useful as model systems. A particularly useful insertion is a loxP sequence flanking a target gene which can be excised by cre. Alternatively, the model system may be a tissue culture system. An “animal model” may, therefore, be tissues from an animal.

The present invention provides, therefore, a mutation in or flanking a genetic locus encoding a target. The mutation may be an insertion, deletion, substitution or addition to the target-coding sequence or its 5′ or 3′ untranslated region.

The animal model of the present invention is useful for screening for agents capable of ameliorating or mimicking the effects of a target. In one embodiment, the animal model produces low amounts of a target.

Another aspect of the present invention provides a genetically modified animal wherein said animal produces low amounts of a target relative to a non-genetically modified animal of the same species. Reference to “low amounts” includes zero amounts or up to about 10% lower than normalized amounts.

Yet another aspect of the present invention provides multiple (i.e. two or more) genes which are modified.

The animal models of the present invention may be in the form of the animals including fish or may be, for example, in the form of embryos for transplantation. The embryos are preferably maintained in a frozen state and may optionally be sold with instructions for use.

The genetically modified animals may also produce larger amounts of a target.

Accordingly, another aspect of the present invention is directed to a genetically modified animal over-expressing genetic sequences encoding a target.

A genetically modified animal includes a transgenic animal, or a “knock-out” or “knock-in” animal as well as a conditional deletion mutant. Furthermore, co-suppression may be used to induce post-transcriptional gene silencing. Co-suppression includes induction of RNAi.

The compounds, agents, medicaments, nucleic acid molecules and other target antagonists or agonists of the present invention can be formulated in pharmaceutical compositions which are prepared according to conventional pharmaceutical compounding techniques. See, for example, Remington's Pharmaceutical Sciences, 18^{th} Ed. (1990, Mack Publishing, Company, Easton, Pa., U.S.A.). The composition may contain the active agent or pharmaceutically acceptable salts of the active agent. These compositions may comprise, in addition to one of the active substances, a pharmaceutically acceptable excipient, carrier, buffer, stabilizer or other materials well known in the art. Such materials should be non-toxic and should not interfere with the efficacy of the active ingredient. The carrier may take a wide variety of forms depending on the form of preparation desired for administration, e.g. topical, intravenous, oral, intrathecal, epineural or parenteral.

For oral administration, the compounds can be formulated into solid or liquid preparations such as capsules, pills, tablets, lozenges, powders, suspensions or emulsions. In preparing the compositions in oral dosage form, any of the usual pharmaceutical media may be employed, such as, for example, water, glycols, oils, alcohols, flavoring agents, preservatives, coloring agents, suspending agents, and the like in the case of oral liquid preparations (such as, for example, suspensions, elixirs and solutions); or carriers such as starches, sugars, diluents, granulating agents, lubricants, binders, disintegrating agents and the like in the case of oral solid preparations (such as, for example, powders, capsules and tablets). Because of their ease in administration, tablets and capsules represent the most advantageous oral dosage unit form, in which case solid pharmaceutical carriers are obviously employed. If desired, tablets may be sugar-coated or enteric-coated by standard techniques. The active agent can be encapsulated to make it stable to passage through the gastrointestinal tract while at the same time allowing for passage across the blood brain barrier. See for example, International Patent Publication No. WO 96/11698. Microparticle sprays, inhalants and fumes are particularly useful compositions.

For parenteral administration, the compound may dissolved in a pharmaceutical carrier and administered as either a solution of a suspension. Illustrative of suitable carriers are water, saline, dextrose solutions, fructose solutions, ethanol, or oils of animal, vegetative or synthetic origin. The carrier may also contain other ingredients, for example, preservatives, suspending agents, solubilizing agents, buffers and the like. When the compounds are being administered intrathecally, they may also be dissolved in cerebrospinal fluid.

The active agent is preferably administered in a therapeutically effective amount. The actual amount administered and the rate and time-course of administration will depend on the nature and severity of the condition being treated. Prescription of treatment, e.g. decisions on dosage, timing, etc. is within the responsibility of general practitioners or specialists and typically takes account of the disorder to be treated, the condition of the individual patient, the site of delivery, the method of administration and other factors known to practitioners. Examples of techniques and protocols can be found in Remington's Pharmaceutical Sciences, supra.

Alternatively, targeting therapies may be used to deliver the active agent more specifically to certain types of cell, by the use of targeting systems such as antibodies or cell specific ligands or specific nucleic acid molecules. Targeting may be desirable for a variety of reasons, e.g. if the agent is unacceptably toxic or if it would otherwise require too high a dosage or if it would not otherwise be able to enter the target cells.

Instead of administering these agents directly, they could be produced in the target cell, e.g. in a viral vector such as described above or in a cell based delivery system such as described in U.S. Pat. No. 5,550,050 and International Patent Publication Nos. WO 92/19195, WO 94/25503, WO 95/01203, WO 95/05452, WO 96/02286, WO 96/02646, WO 96/40871, WO 96/40959 and WO 97/12635. The vector could be targeted to the target cells. The cell based delivery system is designed to be implanted in a patient's body at the desired target site and contains a coding sequence for the target agent. Alternatively, the agent could be administered in a precursor form for conversion to the active form by an activating agent produced in, or targeted to, the cells to be treated. See, for example, European Patent Application No. 0 425 731A and International Patent Publication No. WO 90/07936.

The present invention further provides antibodies to proteinaceous products of differentially expressed genes. Such antibodies are useful in diagnostic and detection assays for inflammatory conditions or for monitoring therapeutic regimens. They may be useful in replacement therapy for genes which are down-regulated during inflammatory conditions.

As above, the gene products are referred to as “targets”.

Antibodies to a target may be polyclonal or monoclonal although monoclonal antibodies are preferred. Antibodies may be prepared by any of a number of means. For the detection of a target, antibodies are generally but not necessarily derived from non-human animals such as primates, livestock animals (e.g. sheep, cows, pigs, goats, horses), laboratory test animals (e.g. mice, rats, guinea pigs, rabbits) and companion animals (e.g. dogs, cats). Generally, antibody based assays are conducted in vitro on cell or tissue biopsies. However, if an antibody is suitably deimmunized or, in the case of human use, humanized, then the antibody can be labeled with, for example, a nuclear tag, administered to a subject and the site of nuclear label accumulation determined by radiological techniques. The target antibody is regarded, therefore, as an inflammatory marker targeting agent. Accordingly, the present invention extends to deimmunized forms of the antibodies for use in inflammatory target imaging in human and non-human subjects. The antibodies may also be from human sources.

For the generation of antibodies to a target, the target is required to be extracted from a biological sample whether this be from animal including human tissue or from cell culture if produced by recombinant means. In some cases, the target is present on the cell surface such as a receptor. In other cases, the target is intracellular and needs to be removed following disruption of the cells. Generally, monocytes and hepatocytes are a convenient source. The target can be separated from the biological sample by any suitable means. For example, the separation may take advantage of any one or more of target surface charge properties, size, density, biological activity and its affinity for another entity (e.g. another protein or chemical compound to which it binds or otherwise associates). Thus, for example, separation of target from the biological sample may be achieved by any one or more of ultra-centrifugation, ion-exchange chromatography (e.g. anion exchange chromatography, cation exchange chromatography), electrophoresis (e.g. polyacrylamide gel electrophoresis, isoelectric focussing), size separation (e.g., gel filtration, ultra-filtration) and affinity-mediated separation (e.g. immunoaffinity separation including, but not limited to, magnetic bead separation such as Dynabead (trademark) separation, immunochromatography, immuno-precipitation). Choice of the separation technique(s) employed may depend on the biological activity or physical properties of the particular target sought or from which tissues it is obtained.

Preferably, the separation of target from the biological fluid preserves conformational epitopes and, thus, suitably avoids techniques that cause denaturation of the target. Persons of skill in the art will recognize the importance of maintaining or mimicking as close as possible physiological conditions peculiar to the target (e.g. the biological sample from which it is obtained) to ensure that the antigenic determinants or active site/s on the target are structurally identical to that of the native target. This ensures the raising of appropriate antibodies in the immunized animal that would recognize the native target.

Immunization and subsequent production of monoclonal antibodies can be carried out using standard protocols as for example described by Köhler and Milstein (Nature 256: 495-499, 1975; Kohler and Milstein, Eur. J. Immunol. 6(7): 511-519, 1976), Coligan et al. (“Current Protocols in Immunology, John Wiley & Sons, Inc., 1991-1997) or Toyama et al. (Monoclonal Antibody, Experiment Manual”, published by Kodansha Scientific, 1987). Essentially, an animal is immunized with the target or a sample comprising a target by standard methods to produce antibody-producing cells, particularly antibody-producing somatic cells (e.g. B lymphocytes). These cells can then be removed from the immunized animal for immortalization.

Where a fragment of the target is used to generate antibodies, it may need to first be associated with a carrier. By “carrier” is meant any substance of typically high molecular weight to which a non- or poorly immunogenic substance (e.g. a hapten) is naturally or artificially linked to enhance its immunogenicity.

Immortalization of antibody-producing cells may be carried out using methods which are well-known in the art. For example, the immortalization may be achieved by the transformation method using Epstein-Barr virus (EBV) (Kozbor et al., Methods in Enzymology 121: 140, 1986). In a preferred embodiment, antibody-producing cells are immortalized using the cell fusion method (described in Coligan et al., 1991-1997, supra), which is widely employed for the production of monoclonal antibodies. In this method, somatic antibody-producing cells with the potential to produce antibodies, particularly B cells, are fused with a myeloma cell line. These somatic cells may be derived from the lymph nodes, spleens and peripheral blood of primed animals, preferably rodent animals such as mice and rats. Mice spleen cells are particularly useful. It would be possible, however, to use rat, rabbit, sheep or goat cells, or cells from other animal species instead.

Specialized myeloma cell lines have been developed from lymphocytic tumors for use in hybridoma-producing fusion procedures (Kohler and Milstein, 1976, supra; Shulman et al., Nature 276: 269-270, 1978; Volk et al., J. Virol. 42(1): 220-227, 1982). These cell lines have been developed for at least three reasons. The first is to facilitate the selection of fused hybridomas from unfused and similarly indefinitely self-propagating myeloma cells. Usually, this is accomplished by using myelomas with enzyme deficiencies that render them incapable of growing in certain selective media that support the growth of hybridomas. The second reason arises from the inherent ability of lymphocytic tumor cells to produce their own antibodies. To eliminate the production of tumor cell antibodies by the hybridomas, myeloma cell lines incapable of producing endogenous light or heavy immunoglobulin chains are used. A third reason for selection of these cell lines is for their suitability and efficiency for fusion.

Many myeloma cell lines may be used for the production of fused cell hybrids, including, e.g. P3X63-Ag8, P3X63-AG8.653, P3/NS1-Ag4-1 (NS-1), Sp2/0-Ag14 and S194/5.XXO.Bu.1. The P3×63-Ag8 and NS-1 cell lines have been described by Köhler and Milstein (1976, supra). Shulman et al. (1978, supra) developed the Sp2/0-Ag14 myeloma line. The S194/5.XXO.Bu.1 line was reported by Trowbridge (J. Exp. Med. 148(1): 313-323, 1978).

Methods for generating hybrids of antibody-producing spleen or lymph node cells and myeloma cells usually involve mixing somatic cells with myeloma cells in a 10:1 proportion (although the proportion may vary from about 20:1 to about 1:1), respectively, in the presence of an agent or agents (chemical, viral or electrical) that promotes the fusion of cell membranes. Fusion methods have been described (Kohler and Milstein, 1975, supra; Kohler and Milstein, 1976, supra; Gefter et al., Somatic Cell Genet. 3: 231-236, 1977; Volk et al., 1982, supra). The fusion-promoting agents used by those investigators were Sendai virus and polyethylene glycol (PEG).

Because fusion procedures produce viable hybrids at very low frequency (e.g. when spleens are used as a source of somatic cells, only one hybrid is obtained for roughly every 1×10⁵ spleen cells), it is preferable to have a means of selecting the fused cell hybrids from the remaining unfused cells, particularly the unfused myeloma cells. A means of detecting the desired antibody-producing hybridomas among other resulting fused cell hybrids is also necessary. Generally, the selection of fused cell hybrids is accomplished by culturing the cells in media that support the growth of hybridomas but prevent the growth of the unfused myeloma cells, which normally would go on dividing indefinitely. The somatic cells used in the fusion do not maintain long-term viability in in vitro culture and hence do not pose a problem. In the example of the present invention, myeloma cells lacking hypoxanthine phosphoribosyl transferase (HPRT-negative) were used. Selection against these cells is made in hypoxanthine/aminopterin/thymidine (HAT) medium, a medium in which the fused cell hybrids survive due to the HPRT-positive genotype of the spleen cells. The use of myeloma cells with different genetic deficiencies (drug sensitivities, etc.) that can be selected against in media supporting the growth of genotypically competent hybrids is also possible.

Several weeks are required to selectively culture the fused cell hybrids. Early in this time period, it is necessary to identify those hybrids which produce the desired antibody, so that they may subsequently be cloned and propagated. Generally, around 10% of the hybrids obtained produce the desired antibody, although a range of from about 1 to about 30% is not uncommon. The detection of antibody-producing hybrids can be achieved by any one of several standard assay methods, including enzyme-linked immunoassay and radioimmunoassay techniques as, for example, described in Kennet et al. (Monoclonal Antibodies and Hybridomas: A New Dimension in Biological Analyses, pp 376-384, Plenum Press, New York, 1980) and by FACS analysis (O'Reilly et al., Biotechniques 25: 824-830, 1998).

Once the desired fused cell hybrids have been selected and cloned into individual antibody-producing cell lines, each cell line may be propagated in either of two standard ways. A suspension of the hybridoma cells can be injected into a histocompatible animal. The injected animal will then develop tumors that secrete the specific monoclonal antibody produced by the fused cell hybrid. The body fluids of the animal, such as serum or ascites fluid, can be tapped to provide monoclonal antibodies in high concentration. Alternatively, the individual cell lines may be propagated in vitro in laboratory culture vessels. The culture medium containing high concentrations of a single specific monoclonal antibody can be harvested by decantation, filtration or centrifugation, and subsequently purified.

The cell lines are tested for their specificity to detect the target of interest by any suitable immunodetection means. For example, cell lines can be aliquoted into a number of wells and incubated and the supernatant from each well is analyzed by enzyme-linked immunosorbent assay (ELISA), indirect fluorescent antibody technique, or the like. The cell line(s) producing a monoclonal antibody capable of recognizing the target but which does not recognize non-target epitopes are identified and then directly cultured in vitro or injected into a histocompatible animal to form tumors and to produce, collect and purify the required antibodies.

These antibodies are target-specific. This means that the antibodies are capable of distinguishing a particular target from other molecules. More broad spectrum antibodies may be used provided that they do not cross-react with molecules in a normal cell.

The present invention further contemplates, therefore, diagnostic protocols such as to determine the presence or absence of differentially produced gene products which provide an assessment of inflammatory conditions such as asthma or propensity for development of inflammatory conditions or to monitor therapeutic regimens. The diagnostic protocols may, therefore, be used in clinical management systems.

Immunological based detection protocols may take a variety of forms. For example, a plurality of antibodies may be immobilized in an array each with different specificities to particular targets. The one or more targets are those generated from the genetic data set comprising one or more differentially expressed nucleotide sequences between inflammatory and non-inflammatory conditions. Cells or cell extracts from a biopsy are then brought into contact with the antibody array and a diagnosis may be made as to the level and type of targets u-regulated or down-regulated on or in the cell.

Other more conventional assays may also be conducted such as by ELISA, Western blot analysis, immunoprecipitation analysis, immunofluorescence analysis, immunochemistry analysis or FACS analysis.

The present invention provides, therefore, a method of detecting in a target or cell comprising same or fragment, variant or derivative thereof comprising contacting the sample with an antibody or fragment or derivative thereof and detecting the level of a complex comprising said antibody and the target or fragment, variant or derivative thereof compared to normal controls wherein altered levels of the target or data set of targets is indicative of the presence or absence of an inflammatory condition or the propensity to develop an inflammatory condition such as asthma.

Preferably, the target is a aP2 or FABP-5 gene product.

As discussed above, any suitable technique for determining formation of the complex may be used. For example, an antibody according to the invention, having a reporter molecule associated therewith, may be utilized in immunoassays. Such immunoassays include but are not limited to radioimmunoassays (RIAs), enzyme-linked immunosorbent assays (ELISAs) and immunochromatographic techniques (ICTs), Western blotting which are well known to those of skill in the art. For example, reference may be made to Coligan et al., 1991-1997, supra which discloses a variety of immunoassays which may be used in accordance with the present invention. Immunoassays may include competitive assays. It will be understood that the present invention encompasses qualitative and quantitative immunoassays.

Suitable immunoassay techniques are described, for example, in U.S. Pat. Nos. 4,016,043, 4,424,279 and 4,018,653. These include both single-site and two-site assays of the non-competitive types, as well as the traditional competitive binding assays. These assays also include direct binding of a labeled antigen-binding molecule to a target antigen. The antigen in this case is the target or a fragment thereof. The terms “target” and “antigen” may be used interchangeably.

Two-site assays are particularly favoured for use in the present invention. A number of variations of these assays exist, all of which are intended to be encompassed by the present invention. Briefly, in a typical forward assay, an unlabeled antigen-binding molecule such as an unlabeled antibody is immobilized on a solid substrate and the sample to be tested brought into contact with the bound molecule. After a suitable period of incubation, for a period of time sufficient to allow formation of an antibody-antigen complex, another antigen-binding molecule, suitably a second antibody specific to the antigen, labeled with a reporter molecule capable of producing a detectable signal is then added and incubated, allowing time sufficient for the formation of another complex of antibody-antigen-labeled antibody. Any unreacted material is washed away and the presence of the antigen is determined by observation of a signal produced by the reporter molecule. The results may be either qualitative, by simple observation of the visible signal, or may be quantitated by comparing with a control sample containing known amounts of antigen. Variations on the forward assay include a simultaneous assay, in which both sample and labeled antibody are added simultaneously to the bound antibody. These techniques are well known to those skilled in the art, including minor variations as will be readily apparent.

In the typical forward assay, a first antibody having specificity for the antigen or antigenic parts thereof is either covalently or passively bound to a solid surface. The solid surface is typically glass or a polymer, the most commonly used polymers being cellulose, polyacrylamide, nylon, polystyrene, polyvinyl chloride or polypropylene. The solid supports may be in the form of tubes, beads, discs of microplates, or any other surface suitable for conducting an immunoassay. The binding processes are well known in the art and generally consist of cross-linking covalently binding or physically adsorbing, the polymer-antibody complex is washed in preparation for the test sample. An aliquot of the sample to be tested is then added to the solid phase complex and incubated for a period of time sufficient and under suitable conditions to allow binding of any antigen present to the antibody. Following the incubation period, the antigen-antibody complex is washed and dried and incubated with a second antibody specific for a portion of the antigen. The second antibody has generally a reporter molecule associated therewith that is used to indicate the binding of the second antibody to the antigen. The amount of labeled antibody that binds, as determined by the associated reporter molecule, is proportional to the amount of antigen bound to the immobilized first antibody.

An alternative method involves immobilizing the antigen in the biological sample and then exposing the immobilized antigen to specific antibody that may or may not be labeled with a reporter molecule. Depending on the amount of target and the strength of the reporter molecule signal, a bound antigen may be detectable by direct labelling with the antibody. Alternatively, a second labeled antibody, specific to the first antibody is exposed to the target-first antibody complex to form a target-first antibody-second antibody tertiary complex. The complex is detected by the signal emitted by the reporter molecule.

From the foregoing, it will be appreciated that the reporter molecule associated with the antigen-binding molecule may include the following:—
(a) direct attachment of the reporter molecule to the antibody;
(b) indirect attachment of the reporter molecule to the antibody; i.e., attachment of the reporter molecule to another assay reagent which subsequently binds to the antibody; and
(c) attachment to a subsequent reaction product of the antibody.

The reporter molecule may be selected from a group including a chromogen, a catalyst, an enzyme, a fluorochrome, a chemiluminescent molecule, a paramagnetic ion, a lanthanide ion such as Europium (Eu³⁴), a radioisotope including other nuclear tags and a direct visual label.

In the case of a direct visual label, use may be made of a colloidal metallic or non-metallic particle, a dye particle, an enzyme or a substrate, an organic polymer, a latex particle, a liposome, or other vesicle containing a signal producing substance and the like.

A large number of enzymes suitable for use as reporter molecules is disclosed in U.S. Patent Nos. U.S. Pat. No. 4,366,241, U.S. Pat. No. 4,843,000, and U.S. Pat. No. 4,849,338. Suitable enzymes useful in the present invention include alkaline phosphatase, horseradish peroxidase, luciferase, β-galactosidase, glucose oxidase, lysozyme, malate dehydrogenase and the like. The enzymes may be used alone or in combination with a second enzyme that is in solution.

Suitable fluorochromes include, but are not limited to, fluorescein isothiocyanate (FITC), tetramethylrhodamine isothiocyanate (TRITC), R-Phycoerythrin (RPE), and Texas Red. Other exemplary fluorochromes include those discussed by International Patent Publication No. WO 93/06121. Reference also may be made to the fluorochromes described in U.S. Pat. Nos. 5,573,909 and 5,326,692. Alternatively, reference may be made to the fluorochromes described in U.S. Pat. Nos. 5,227,487, 5,274,113, 5,405,975, 5,433,896, 5,442,045, 5,451,663, 5,453,517, 5,459,276, 5,516,864, 5,648,270 and 5,723,218.

In the case of an enzyme immunoassay, an enzyme is conjugated to the second antibody, generally by means of glutaraldehyde or periodate. As will be readily recognized, however, a wide variety of different conjugation techniques exist which are readily available to the skilled artisan. The substrates to be used with the specific enzymes are generally chosen for the production of, upon hydrolysis by the corresponding enzyme, a detectable color change. Examples of suitable enzymes include those described supra. It is also possible to employ fluorogenic substrates, which yield a fluorescent product rather than the chromogenic substrates noted above. In all cases, the enzyme-labeled antibody is added to the first antibody-antigen complex, allowed to bind, and then the excess reagent washed away. A solution containing the appropriate substrate is then added to the complex of antibody-antigen-antibody. The substrate will react with the enzyme linked to the second antibody, giving a qualitative visual signal, which may be further quantitated, usually spectrophotometrically, to give an indication of the amount of antigen which was present in the sample.

Alternately, fluorescent compounds, such as fluorescein, rhodamine and the lanthanide, europium (EU), may be chemically coupled to antibodies without altering their binding capacity. When activated by illumination with light of a particular wavelength, the fluorochrome-labeled antibody adsorbs the light energy, inducing a state to excitability in the molecule, followed by emission of the light at a characteristic color visually detectable with a light microscope. The fluorescent-labeled antibody is allowed to bind to the first antibody-antigen complex. After washing off the unbound reagent, the remaining tertiary complex is then exposed to light of an appropriate wavelength. The fluorescence observed indicates the presence of the antigen of interest. Immunofluorometric assays (IFMA) are well established in the art and are particularly useful for the present method. However, other reporter molecules, such as radioisotope, chemiluminescent or bioluminescent molecules may also be employed.

Monoclonal antibodies to a target may also be used in ELISA-mediated detection of the target. This may be undertaken in any number of ways such as immobilizing anti-target antibodies to a solid support and contacting these with cells or cell extract. Labeled anti-target antibodies are then used to detect immobilized target. This assay may be varied in any number of ways and all variations are encompassed by the present invention. This approach enables rapid detection and quantitation of target levels.

In another embodiment, the method for detection comprises detecting the level of expression in a cell of a polynucleotide encoding a target. Overall expression of a genetic data set of polynucleotides or changes in levels of the genetic data set may also provide a pattern which gives a fingerprint of an inflammatory condition or a propensity for one to develop or the efficacy of a therapeutic regimen. Expression of such a polynucleotide or genetic data set of polynucleotides may be determined using any suitable technique. For example, a labeled polynucleotide encoding a target may be utilized as a probe in a Northern blot of an RNA extract obtained from the cell. A variety of automated solid-phase detection techniques are also appropriate. For example, a very large scale immobilized primer arrays (VLSIPS (trademark)) are used for the detection of nucleic acids as, for example, described by Fodor et al. (Science 251: 767-777, 1991) and Kazal et al. (Nature Medicine 2: 753-759, 1996). A variety of gene chips are also known. The above genetic techniques are well known to persons skilled in the art.

For example, a differentially expressed RNA transcript is isolated from a cellular sample suspected of containing target RNA. RNA can be isolated by methods known in the art, e.g. using TRIZOL (trademark) reagent (GIBCO-BRL/Life Technologies, Gaithersburg, Md.). Oligo-dT, or random-sequence oligonucleotides, as well as sequence-specific oligonucleotides can be employed as a primer in a reverse transcriptase reaction to prepare first-strand cDNAs from the isolated RNA. Resultant first-strand cDNAs are then amplified with sequence-specific oligonucleotides in PCR reactions to yield an amplified product.

“Polymerase chain reaction” or “PCR” refers to a procedure or technique in which amounts of a preselected fragment of nucleic acid, RNA and/or DNA, are amplified as described in U.S. Pat. No. 4,683,195. Generally, sequence information from the ends of the region of interest or beyond is employed to design oligonucleotide primers. These primers will be identical or similar in sequence to opposite strands of the template to be amplified. PCR can be used to amplify specific RNA sequences and cDNA transcribed from total cellular RNA. See generally Mullis et al. (Quant. Biol. 51: 263, 1987; Erlich, eds., PCR Technology, Stockton Press, NY, 1989). Thus, amplification of specific nucleic acid sequences by PCR relies upon oligonucleotides or “primers” having conserved nucleotide sequences wherein the conserved sequences are deduced from alignments of related gene or protein sequences, e.g. a sequence comparison of mammalian target genes. For example, one primer is prepared which is predicted to anneal to the antisense strand and another primer prepared which is predicted to anneal to the sense strand of a cDNA molecule which encodes a target.

To detect the amplified product, the reaction mixture is typically subjected to agarose gel electrophoresis or other convenient separation technique and the relative presence of the target specific amplified DNA detected. For example, target amplified DNA may be detected using Southern hybridization with a specific oligonucleotide probe or comparing is electrophoretic mobility with DNA standards of known molecular weight. Isolation, purification and characterization of the amplified target DNA may be accomplished by excising or eluting the fragment from the gel (for example, see references Lawn et al., Nucleic Acids Res. 2: 6103, 1981; Goeddel et al., Nucleic Acids Res. 8: 4057-1980), cloning the amplified product into a cloning site of a suitable vector, such as the pCRII vector (Invitrogen), sequencing the cloned insert and comparing the DNA sequence to the known sequence of the target. The relative amounts of target mRNA and cDNA can then be determined.

Real-time PCR is particularly useful in determining transcriptional levels of PCR genes. Determination of transcriptional activity also includes a measure of potential translational activity based on available mRNA transcripts. Real-time PCR as well as other PCR procedures use a number of chemistries for detection of PCR product including the binding of DNA binding fluorophores, the 5′ endonuclease, adjacent liner and hairpin oligoprobes and the self-fluorescing amplicons. These chemistries and real-time PCR in general are discussed, for example, in Mackay et al., Nucleic Acids Res 30(6): 1292-1305, 2002; Walker, J. Biochem. Mol. Toxicology 15(3): 121-127, 2001; Lewis et al., J. Pathol. 195: 66-71, 2001.

The present invention further provides gene arrays and/or gene chips to screen for the up- or down-regulation of mRNA transcripts. This aspect of the present invention is particularly useful in identifying conditions which result in the up- or down-regulation of target gene transcripts. Furthermore, compounds can be readily screened which up- or down-regulate target transcripts and in particular aP2 and/or FABP-5.

The present invention is further described by the following non-limiting Examples.

### EXAMPLE 1

### Gene Profiling of IL-4- and IL-13-Stimulated NHBE

Bronchial epithelial cells respond to, and are active participants in, the asthmatic inflammatory response.

(a) Maintenance of Normal Human Bronchial Epithelial (NHBE) Cells

NHBE primary cell lines were purchased from Clonetics (San Diego, Calif.). Both NHBE cell lines, lot 8F1142 and 7F1482, were isolated from Caucasian males, ages 18 months and 32 years, respectively. NHBE cells were maintained in Clonetics bronchial epithelial growth media (BEGM), which included supplements of 52 μg/ml bovine pituitary extract, 0.5 μg/ml hydrocortisone, 0.5 μg/ml human recombinant epidermal growth factor, 0.5 μg/ml epinephrine, 10 μg/ml transferrin, 5 μg/ml insulin, 0.1 μg/ml retinoic acid, 6.5 μg/ml triiodothryonine, 50 μg/ml gentamycin and 50 μg/ml amphotericin B (Clonetics). Medium was replaced every three to four days. When confluent, cells were subcultured at a ratio of 1:3.

(b) Stimulation of NHBE

To model some of the transcriptional events that take place at the bronchial epithelium during the asthmatic inflammatory response, NHBE were stimulated with the allergy-associated cytokines IL-4 and IL-13.

When NHBE cells were 80% confluent and between passage 7 and 8, they were washed in PBS (Gibco) and starved for 24 h in Clonetics bronchial epithelial cell basal medium (BEBM) containing 0.1% w/v BSA. The cells were then exposed to the following stimuli: 10 ng/ml IL-4 (BD), 10 ng/ml IL-13 (BD), 10 ng/ml IL-1β (Peprotech), 20 ng/ml IL-3 (BD), 5 ng/ml IL-6 (BD), 10 ng/ml IL-10 (BD), 28 ng/ml interferon-γ (BD), 10 ng/ml TNFα (Peprotech), 50 ng/ml phorbol myristate acetate (PMA; Sigma) or 100 ng/ml LPS (Sigma).

(c) Increased Expression of aP2

A preliminary time course experiment in IL-4 and IL-13 stimulated NHBE identified 18 h as a time point associated with strong gene regulation and this time point was selected for subsequent analysis. Gene expression in unstimulated- and IL-4- and IL-13-stimulated NHBE was measured using Affymetrix U95A Gene Chips. The experiment was performed twice, using two independent NHBE lines. One novel finding was increased expression of the adipocyte gene aP2 in the cytokine stimulated NHBE cells (Table 3).

TABLE 3
aP2 gene expression is up-regulated by IL-4 and IL-13

Fold-Change

| | IL-4 | IL-13 |
|---|---|---|
| aP2 | 33.4 | 31.8 |

NHBE cells were stimulated with 10 ng/ml IL-4 or 10 ng/ml IL-13. After 18 h, gene expression in these cells, and in unstimulated NHBE cells, was analysed using Affymetrix U95A chips. The fold-change in gene expression following cytokine stimulation compared to unstimulated NHBE cells is shown. Data are the mean of both micro-array experiments.

### EXAMPLE 2

### Confirmation of Expression Using Real-Time PCR

To confirm the micro-array results we used real-time PCR.

(a) RNA Extraction

Total RNA was isolated from cells using the RNeasy Total RNA Isolation Kit (Qiagen, Chatswort, Calif.) or Trizol (Invitrogen, CA) as per the manufacturer's instructions.

(b) Monitoring Gene Expression

cDNA was made using Reverse-IT RTase Blend Kit (ABgene, UK) or Avian myeloblastosis virus Reverse Transcriptase (Promega, Madison, Wis.) according to manufacturer's instructions. Oligo-p(dt)15 primer (Roche Molecular Biochemicals) was used at 1 μM in both cDNA preparation methods. Following cDNA synthesis, 1 μl of cDNA template was used for each PCR. Real-time PCR was conducted using Light Cycler-FastStart DNA Master SYBR Green I kit (Roche Molecular Biochemicals) according to manufacturer's specifications using 2 mM MgCl₂ and 1 μM primers. Human aP2 forward and reverse primers and FABP-5 forward and primers were designed from Genbank sequences using Primer3 software (Rozen and Skaletsky, Methods Mol. Biol. 132: 365-386, 2000):

| | |
|---|---|
| aP2 forward | |
| 5′ GGCATGGCCAAACCTAACAT-3′ | [SEQ ID NO:1] |
| aP2 reverse | |
| 5′ TTCCATCCCATTTCTGCACAT-3′ | [SEQ ID NO:2] |
| FABP-5 forward | |
| 5′ GCA ATG GCC AAG CCA GAT TGT-3′ | [SEQ ID NO:3] |
| FABP-5 reverse | |
| 5′ CCC ATC CCA CTC CTG ATG CT-3′ | [SEQ ID NO:4] |

GAPDH forward and reverse primers were as published by Jordan et al., J. Clin. Invest. 104(8): 1061-1069, 1999:

| | |
|---|---|
| GAPDH forward | |
| 5′ GACATCAAGAAGGTGGTGAA-3′ | [SEQ ID NO:5] |
| GAPDH reverse | |
| 5′ TGTCATACCAGGAAATGAGC-3′ | [SEQ ID NO:6] |

After an initial denaturation for 10 min at 95° C., the samples were run for 40 cycles at 95° C. (15 s), 63° C. (5 s), and 72° C. (10 s). At the end of each cycle, the fluorescence was measured in a single step in channel F1. After the 40th cycle, the specimens were heated to 95° C. and cooled to 65° C. for 15 s. All heating and cooling steps were performed with a slope of 20° C./sec. The temperature was then raised to 95° C. at a rate of 0.1° C./sec and fluorescence was measured continuously (channel F1) to obtain a melting curve for the PCR products. Each gene was normalized to a housekeeping gene GAPDH before fold change was calculated (using crossing point values) to account for variations between different samples. The aP2 PCR product was confirmed by size on a 2% w/v agarose gel and by sequencing at Sydney University Prince Alfred Macromolecular Analysis Centre, NSW, Australia.

The results using this technology corresponded closely to our earlier micro-array finding (Table 4).

TABLE 4
Real-time PCR confirmation of microarray aP2 expression data

Fold-Change

| | IL-4 | IL-13 |
|---|---|---|
| aP2 | 65 | 56 |

Using the same RNA samples as were used for the microarray experiments, aP2 gene expression was analysed using real-time PCR. The fold-change in gene expression following cytokine stimulation compared to unstimulated NHBE cells is shown. Data are the mean from the two sets of RNA that were used in the array experiments.

### EXAMPLE 3

### Expression of aP2 in Other Cell Types

Using the microarray database in the Arthritis and Inflammation Program at the Garvan Institute, NSW, Australia, the expression of aP2 in a range of other inflammatory cell types was examined.

Depending on the quantity of RNA available, cRNA was prepared according to the GeneChip Expression Analysis Technical Manual (Array experiment 1; Affymetrix, Santa Clara, Calif.) or the cRNA methods published in Baugh et al., Nucleic Acids Res. 29(5): E29, 2001 (Array experiment 2). The GeneChip Expression Analysis protocol involved cDNA synthesis from 20 μg of total RNA using a poly(T) primer containing a T7 RNA polymerase promoter (Geneworks, Australia):

GGC CAG TGA ATT GTA ATA CGA CTC ACT ATA GGG AGG CGG-(dT)₂₄ [SEQ ID NO:7]

cRNA was transcribed from cDNA and biotinylated using the BioArray High Yield RNA Transcript Labeling Kit (Enzo Diagnostics, Farmingdale, N.Y.). Twenty micrograms of cRNA was fragmented by heating at 94° C. for 35 min in fragmentation buffer (40 mM Tris acetate (pH 8.1), 125 mM KOAc, 30 mM MgOAc) prior to hybridization. For the small-scale cRNA amplification (Baugh et al., 2001, supra), cDNA synthesis volumes were different from the GeneChip Expression Analysis Technical Manual but reaction component concentrations, incubation times and temperatures were conserved. Five hundred nanograms of RNA was used and 15 μg cRNA was fragmented prior to hybridization.

Hybridization cocktails were then made by adding fragmented cRNA, control cRNAs, grid alignment oligonucleotides and blocking reagents. These mixtures were hybridised overnight (˜16 h) to individual Test3 (Affymetrix) arrays at 45° C., under constant rotation at 60 rpm. Washing and staining of the hybridized arrays were performed by an Affymetrix Fluidics Station, according to the manufacturer's protocols. Fluorescent signals were measured on the arrays using the Agilent GeneArray Laser Scanner and gene transcript levels were determined and scaled to 150 using algorithms in MicroArray Analysis Suite Software 5.0 (Affymetrix). For each array experiment, the hybridization cocktails met the test three criteria (background less then 150, GAPDH and β-actin 3′/5′ ratios less then three and similar scaling factors between samples), and were used to probe Affymetrix U95A GeneChips. Relative mRNA expression levels on the IL-4 and IL-13 stimulated NHBE arrays were expressed as plus or minus fold changes when compared to the control NHBE array.

Limited aP2 expression was found in other inflammatory microarray paradigms—besides NHBE cells, only dendritic cells and mature mast cells were consistently found to express aP2 (Table 5). In mast cells, aP2 expression was unchanged following 2 h activation by FcεR1 cross-linking (Table 6).

TABLE 5
Expression of aP2 in microarray experiments
Array experiment

| Present | Absent |
|---|---|
| NHBE IL-4 | NHBE ctrl |
| NHBE IL-13 | Mast ctrl |
| Mast ctrl | Mast IgE |
| Mast IgE | BSMC IL-13 |
| Mast wk 9 | BSMC ctrl |
| RA IL-1 | HMC-1 |
| ImDC | OA ctrl |
| DC6 | OA TNF |
| DC48 | RA ctrl |
| | RA ctrl |
| | RA IL-1 |
| | RA TNF |
| | RA TNF |
| | RA ctrl |
| | a4b7 |
| | BSMC ctrl |
| | BSMC IL-13 |
| | BSMC IL-4 |
| | CCR7− |
| | CCR7+ |
| | CLA |
| | RA IL-1 |
| | RA TNF |
| | RA TNF |
| | CCR7+ |
| | CCR7+ |
| | CCR7− |
| | CCR7− |
| | CD57+ |
| | CD57− |
| | Mast wk4 |
| | Mast wk4 |
| | Mast wk9 |

Table 5 shows individual micro-array experiments in which aP2 was called “present” or “absent” by MicroArray Analysis Suite Software. Where the same type of array experiment is listed more than once, this represents repeat experiments or alternative GeneChips.

TABLE 6
Regulation of aP2 gene expression in microarray experiments

| Cell type | Regulation | Fold change |
|---|---|---|
| Bronchial epithelial cells | | |
| NHBE IL-13 vs ctrl | I | 45.3 |
| NHBE IL-4 vs ctrl | I | 48.5 |
| NHBE IL-13 vs ctrl | I | 18.4 |
| NHBE IL-4 cs ctrl | I | 18.4 |
| Dendritic cells | | |
| DC6 vs ctrl | D | 1.9 |
| DC48 vs ctrl | D | 10.0 |
| Mast cells | | |
| Mast IgE vs ctrl | NC | |
| Mast IgE vs ctrl | NC | |
| Mast wk9 vs wk4 | I | 10.6 |

Regulation of aP2 gene expression was examined for all comparison arrays in which aP2 expression was detected. Positive or negative fold change indicates greater or lesser gene expression, respectively, in the first-named array. I, increased; D, decreased; NC, no change. Where the same type of array comparison is listed more than once, this represents repeat experiments.

### EXAMPLE 4

### Time Course and Regulation of aP2 Expression in NHBE Cells

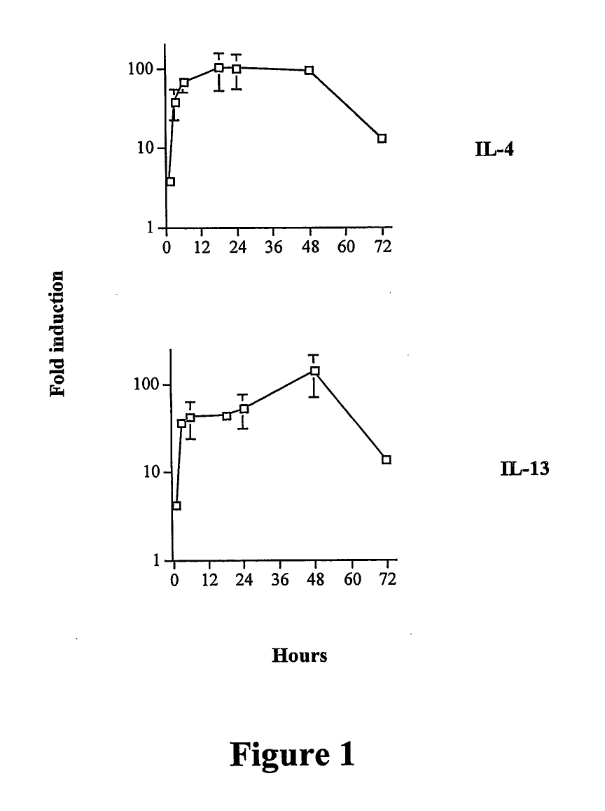

aP2 was originally considered to be an adipocyte specific gene, and although more recent studies have identified aP2 expression in several other cell types, the finding of aP2 expression in primary bronchial epithelial cells was novel and unexpected. Using real-time PCR, aP2 gene expression was further characterized in these cells. Following stimulation with IL-4 or IL-13, aP2 gene expression was up-regulated as early as 1 h, with maximal expression detected at 24-48 h (FIG. 1). Expression fell away rapidly by 72 h, approaching that of unstimulated cells.

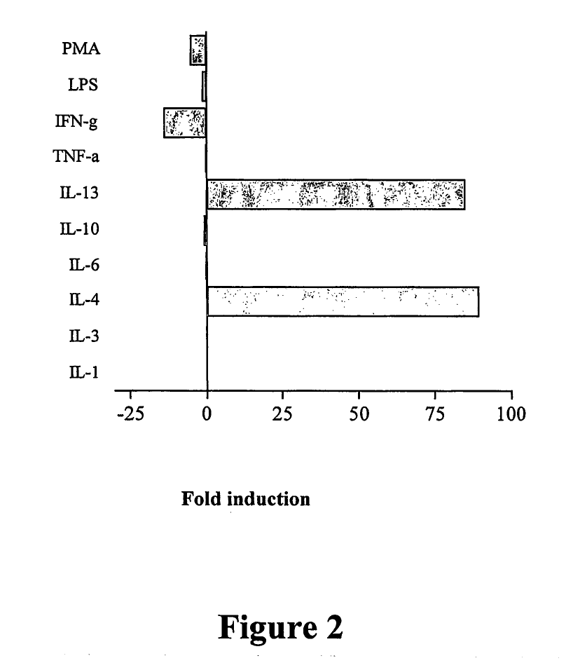

A range of stimuli was tested for their ability to regulate aP2 expression in NHBE cells (FIG. 2). IL-1, IL-3, IL-6, IL-10, TNFα and LPS had no effect on aP2 expression. However, the prototypic type 1 cytokine, IFN-γ, strongly down-regulated aP2 expression in NHBE cells. PMA stimulation resulted in a slight down-regulation. In a subsequent experiment, it was also found that the PPARγ-ligand rosiglitazone and the PPARα-ligand WY14643 had little or no effect on aP2 expression.

### EXAMPLE 5

### Expression of FABP-5 in NHBE Cells and other Cell Types

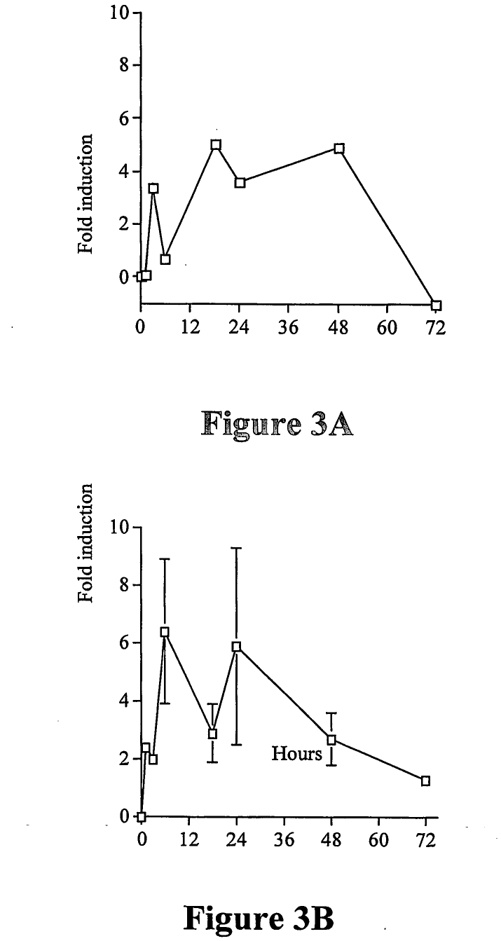

FABP-5 encodes a fatty acid binding protein that has been functionally associated with aP2. The microarray data indicated that FABP-5 was present in NHBE (Table 7) and that its expression was mildly up-regulated by IL-4 and IL-13 (Table 8). Real-time PCR was used to confirm and extend these results FIG. 3). IL-4 and IL-13 both up-regulated FABP-5 expression with similar kinetics in NHBE cells, although the degree of regulation was considerably lower than that observed for aP2.

Using the microarray database, expression of FABP-5 in a range of other inflammatory cell types was also examined. In contrast to the results obtained for aP2, FABP-5 was found to be expressed in a broad range of cell types (Table 7) but its expression was not strongly regulated in the inflammatory array systems (Table 8).

TABLE 7
Expression of FABP-5 in array experiments
Array experiment

| Present | Absent |
|---|---|
| CD57+ T cell | Ctrl eosinophil |
| CD57− T cell | 2 h eosinophil |
| CD8+ CCR7− RO+ | CD8+ CCR7− RO− |
| Control mast | CCR7+ T cell |
| IgE mast | CCR7−T cell |
| Th1 | CCR7− |
| Th2 | CCR7− |
| wk 4 mast | CCR7+ |
| wk 9 mast | CCR7+ |
| α4β7 | CLA |
| α4β7 | CLA |
| BSMC | RA IL-1 |
| BSMC-IL-13 | RA TNF |
| BSMC-IL-4 | RA TNF |
| mast IgE | |
| mast ctrl | |
| HMC-1 | |
| NHBE ctrl | |
| NHBE ctrl | |
| NHBE IL-13 | |
| NHBE IL-13 | |
| NHBE IL-4 | |
| NHBE IL-4 | |
| RA cont | |
| RA TNF | |
| RA 80 ctrl | |
| RA80 IL-4 | |
| BSMC ctrl | |
| BSMC IL-13 | |
| OA ctrl | |
| OA TNF | |
| RA ctrl | |
| RA ctrl | |
| RA IL-1 | |
| RA TNF | |
| ImDC | |
| DC6 | |
| DC48 | |

Table 7 shows individual microarray experiments in which FABP-5 was called “present” or “absent” by MicroArray Analysis Suite Software. Where the same type of array experiment is listed more than once, this represents repeat experiments or alternative GeneChips.

TABLE 8
Regulation of FABP-5 gene expression in microarray experiments

| Cell type | Regulation | Fold change |
|---|---|---|
| Bronchial epithelial cells | | |
| NHBE IL-13 vs ctrl | I | 1.5 |
| NHBE IL-4 vs ctrl | I | 1.4 |
| NHBE IL-13 vs ctrl | NC | |
| NHBE IL-4 cs ctrl | I | 2 |
| Bronchial smooth muscle | | |
| BSMC IL-13 vs ctrl | NC | |
| BSMC IL-13 vs ctrl | I | 1.7 |
| Mast cells | | |
| Mast IgE vs ctrl | NC | |
| Mast IgE vs ctrl | I | 1.9 |
| Mast wk9 vs wk4 | I | 6.8 |
| Bdendritic cells | | |
| DC6 vs ctrol | NC | |
| DC48 vs ctrl | NC | |
| Synovial fibroblasts | | |
| OA ctrl vs RA ctrl | D | −3.1 |
| OA ctrl vs RA ctrl | NC | |
| OA TNF vs OA ctrl | NC | |
| OA TNF vs RA TNF | D | −4.9 |
| RA TNF vs RA ctrl | NC | |
| RA TNF vs RA ctrl | NC | |
| RA IL-1 vs ctrl | NC | |
| RA IL-4 vs ctrl | NC | |
| RA TNF vs ctrl | NC | |
| T lymphocytes | | |
| α4β7 vs CLA | NC | |
| CD57+ vs CD57− | NC | |
| CD8+CCR7−, RO− vs RO+ | D | −1.8 |
| Th2 vs Th1 | NC | |

Table 8 shows regulation of FABP-5 gene expression was examined for all comparison arrays in which FABP-5 expression was detected. Positive/negative fold change indicates greater/lesser gene expression in the first-named array, respectively. I, increased; D, decreased; NC, no change. Where the same type of array comparison is listed more than once, this represents repeat experiments.

### EXAMPLE 6

### Expression of aP2 Protein in NHBE Cells

Immunofluorescent staining confirmed that increased aP2 gene expression resulted in corresponding changes in aP2 protein expression.

NHBE cells were grown in chamber slides and treated with culture medium alone, or with medium supplemented with 10 ng/ml IL-4 or 10 ng/ml IL-13. After 24 h, the culture medium was removed and the cells were air-dried for 30 min. The cells were fixed in 1% v/v paraformaldehyde for 20 min at room temperature. The slides were washed in PBS and the cells were permeabilised in 70% v/v ethanol at −20° C. for 20 min. The cells were washed in PBS-Triton for 5 min, and then blocked for 60 min with 10% v/v normal goat serum in 2% v/v BSA/Tris-buffered saline (TBS). The normal goat serum was removed and anti-mouse aP2 (1:1000 dilution in 2% BSA/TBS) or rabbit isotype control (1:4 dilution; Zymed) was added. The slides were incubated overnight at room temperature, washed 3×5 min in TBS-Triton (TBS-T), and incubated with secondary Ab (TRITC-conjugated anti-rabbit Ig; dilution 1:100) for 1 h at room temperature. The slides were washed in TBS-T for 5 min, and cover-slipped after the addition of Vectashield. The slides were examined on a confocal microscope.

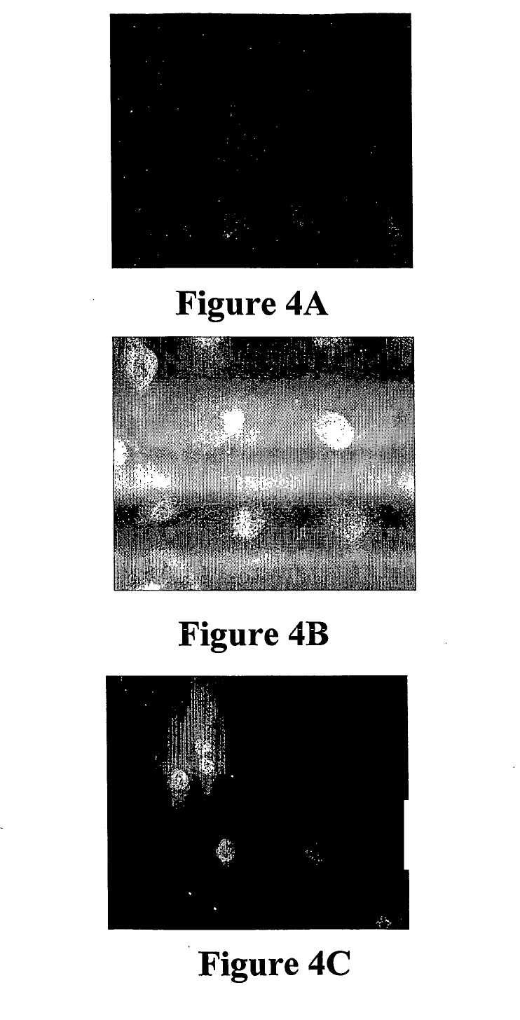

The intensity of aP2 staining in IL-4- or IL-13-stimulated NHBE cells was considerably greater than that observed in unstimulated NHBE cells (FIG. 4). In IL-4- or IL-13-stimulated cells we consistently observed a significant nuclear localisation of aP2. This is consistent with the proposed involvement of aP2 in shuttling lipophilic ligands into the nucleus for nuclear receptors such as PPARγ.

### EXAMPLE 7

### Expression of aP2 Protein in a Mouse Model of Asthma

As IL-4 and IL-13 are major contributors to the development of allergic inflammation, a mouse model of asthma was used to analyze aP2 expression. BALB/c mice were immunised intraperitoneally on days 0 and 14 with PBS in alum or 100 μg ovalbumin (OVA) in alum. On days 28, 30, 32 and 34 the mice are exposed for 20 minutes to an aerosol of PBS or OVA (1% w/v OVA in PBS) generated by a Vitalair RapidNeb nebuliser (Allersearch, Australia). The mice were killed on day 35. The lungs were frozen in OCT and stored at −80° C. until processed for immunohistochemistry.

Lungs from control- and OVA-allergic-mice were frozen in OCT. Sections 8 μm thick were cut and air-dried for 15 min. The sections were fixed in 1% v/v paraformaldehyde/TBS for 20 min and washed once in TBS. The sections were quenched with 0.3% v/v H₂O₂ in methanol for 20 min and washed for 5 min in TBS-T. The sections were then blocked with normal goat serum (1:5 dilution in 2% w/v BSA/TBS) for 60 min, after which the primary Ab (1:1000 dilution in 2% w/v BSA/TBS) was added and the sections incubated overnight at RT. The sections were washed 3× in TBS-T and goat anti-rabbit Ig-biotin (1:100) was added for 1 h at RT. The sections were washed 3 times in TBS-T, and streptavidin-HRP (1:100) was added for 40 min at RT. After washing 3× in TBS-T, color was developed with 3,3′ diaminobenzidine followed by counterstaining with Giemsa stain.

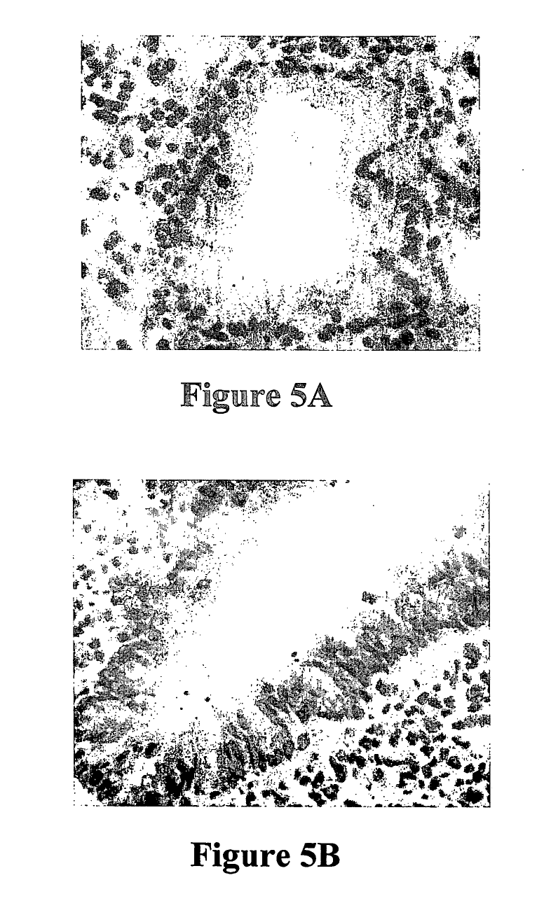

aP2 expression in the lungs of control mice was mostly restricted to airway epithelium, with occasional deposits of fat showing intense aP2 expression. A similar pattern of expression was observed in mice with OVA-induced allergic inflammation. However, the intensity of staining was considerably higher than that observed in control mice (FIG. 5).

### EXAMPLE 8

### IL-4, IL-13 and IFNγ also Regulate aP2 Expression in THP-1 Cells

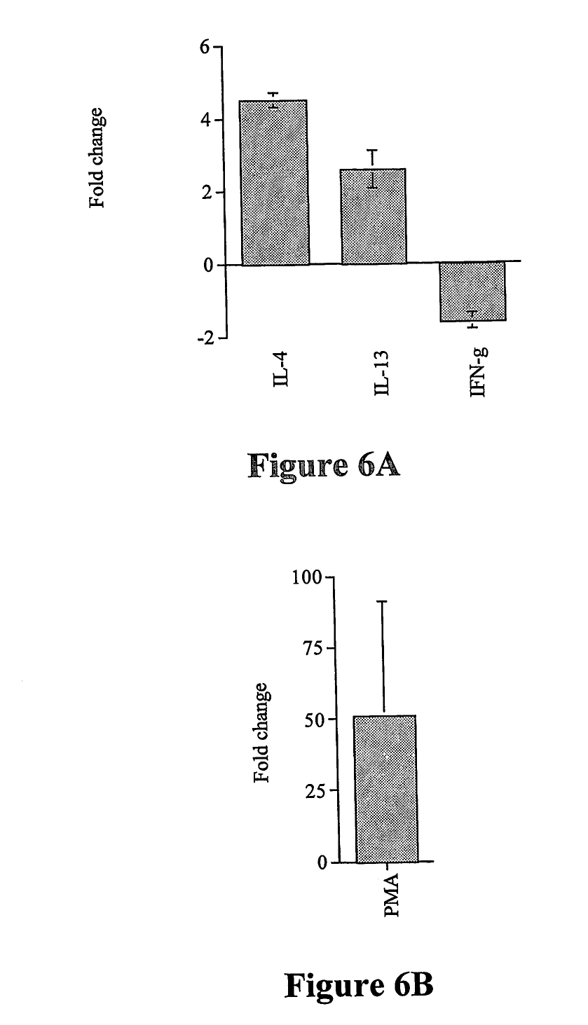

Although aP2 expression has also been demonstrated in macrophages and adipocytes, little attention has been given to regulation of aP2 expression in these cells by cytokines. To address this issue, the effect of IL-4, IL-13 and IFN-γ on expression of aP2 in the human monocyte cell line THP-1 was examined. The results were similar to the findings in NHBE cells, although the degree of regulation was less; IL-4 and IL-13 stimulated aP2 expression and IFN-γ reduced expression (FIG. 6).

### EXAMPLE 9

### Descriptions of Single Microarray GeneChips and GeneChip Comparisons

Tables 9 and 10 provide descriptions of single microarray GeneChips and GeneChip comparisons, respectively.

TABLE 9
Description of single microarray GeneChips

| GeneChip parameter | Description |
|---|---|
| RA control | Synovial tissue was obtained from Rheumatoid Arthritis (RA) |
| | patients undergoing surgery at St Vincent's Hospital, Sydney, |
| | Australia. This tissue was used to establish fibroblast-like |
| | synoviocyte cultures and gene expression was examined |
| RA IL-1 | Synoviocytes from RA patients were stimulated with 10 ng/ml |
| | of the cytokine Interleukin (IL)-1β for 4 hours at 37° C. and gene |
| | expression was examined. |
| RA TNF | Synoviocytes from RA patients were stimulated with 10 ng/ml |
| | of the cytokine Tumour Necrosis Factor (TNF)-α for 4 hours at |
| | 37° C. and gene expression was examined. |
| HMC1 | HMC1 is an immature human mast cell line derived from a |
| | leukemia patient. |
| α4 β7 | α4β7, an integrin adhesion molecule is a marker for gut homing |
| | effector memory T cells. These cells were isolated from human |
| | peripheral blood using cell sorting and gene expression |
| | examined. |
| BSCM cont | Bronchial Smooth Muscle Cells (BSMCs) were obtained |
| | commercially from Clonetics (San Diego, CA) and gene |
| | expression examined. |
| BSCM IL-4 | BSMCs were obtained commercially from Clonetics (San Diego, |
| | CA) and activated with 10 ng/ml of IL-4 for 18 hours at 37° C. |
| BSCM IL-13 | BSMCs were obtained commercially from Clonetics (San Diego, |
| | CA) and activated with 10 ng/ml of IL-13 for 18 hours at 37° C. |
| CLA | Cutaneous Lymphocyte Antigen (CLA) is a marker for skin |
| | homing effector memory T cells. These cells were isolated from |
| | human peripheral blood using cell sorting. |
| MC control | Mast cells were derived from human cord blood using a ficoll |
| | density gradient and differentiated to mature mast cells over 6-9 |
| | weeks using 100 ng/ml stem cell factor, 10 ng/ml IL-10 and 5 ng/ml |
| | IL-6. Gene expression was then examined. |
| MC anti-IgE Wk 6 | Mast cells were derived from human cord blood using a ficoll |
| | density gradient and differentiated to mature mast cells over 6-9 |
| | weeks using 100 ng/ml stem cell factor, 10 ng/ml IL-10 and 5 ng/ml |
| | IL-6. Once mature, cells were first primed with 4 μg/ml |
| | human IgE anti-NP for 18 hours and then activated with 5 μg/ml |
| | mouse anti-human IgE for 2 hours by crosslinking the IgE |
| | receptors. |
| NHBE 18 hr control | NHBE primary cell lines were purchased from Clonetics (San |
| | Diego, CA) and were used to represent human lung epithelial |
| | cell behaviour in response to Th2 cytokines IL-4 and IL-13. |
| | Both NHBE cell lines, lot 8F1142 and 7F1482, were isolated |
| | from Caucasian males aged 18 months and 32 years |
| | respectively. |
| | NHBE cells were maintained in Clonetics bronchial epithelial |
| | growth media (BEGM), which included supplements of 52 mg/l |
| | bovine pituitary extract, 0.5 mg/l hydrocortisone, 0.5 mg/l |
| | human recombinant epidermal growth factor, 0.5 mg/l |
| | epinephrine, 10 mg/l transferrin, 5 mg/l insulin, 0.1 mg/l retinoic |
| | acid, 6.5 mg/l Triiodothryonine, 50 mg/l gentamicin, and 50 mg/l |
| | amphotericin B (Clonetics). Media was replaced every |
| | three to four days. When confluent, cells were subcultured at a |
| | ratio of 1:3, 0.025% trypsin-EDTA (Gibco) was used to dislodge |
| | cells and 100% v/v foetal bovine serum for neutralization |
| NHBE 18 hr IL-13 | Normal Human Bronchial Epithelial (NHBE) cells stimulated |
| | with 10 ng/ml of IL-l3 for 18 hours at 37° C. |
| NHBE 18 hr IL-4 | NHBE cells stimulated with 10 ng/ml of IL-4 for 18 hours at |
| | 37° C. |
| CCR7+ | CCR7+ (CD4+, CD45RO+) represent Central Memory T cells |
| | and were isolated from human peripheral blood using cell |
| | sorting techniques. |
| CCR7− | CCR7− (CD4+, CD45RO+) represent Effector Memory T cells |
| | and were isolated from human peripheral blood using cell |
| CD57+ | CD57+ (CXCR5+, CD4+) represent T Follicular Homing cells |
| | were isolated from human tonsil tissue using cell sorting. |
| CD57− | CD57− (CXCR5+, CD4+) are not T Follicular Homing cells and |
| | were isolated from human tonsil tissue using cell sorting. |
| CD8+ CCR7− RO+ | Cytotoxic effector memory (CD8+, CCR7−, RO−) were isolated |
| | from human peripheral blood using cell sorting. |
| CD8+ CCR7− RO− | Cytotoxic terminally differentiated T cells (CD8+, CCR7−, RO+) |
| | were isolated from human peripheral blood using cell sorting. |
| TH1 human | CD4+ T cells were isolated from human umbilical cord blood |
| | and polarized in vitro using IL-12 and neutralising IL-4. |
| TH2 human | CD4+ T cells were isolated from human umbilical cord blood |
| | and polarized in vitro using IL-4 and neutralizing IL-12 and |
| | interferon γ. |
| Control eosinophils | Eosinophils were isolated from human peripheral blood using a |
| | percoll gradient method (Hansel et al., 1989) with modifications. |
| 2 hr eosinophils | Eosinophils were isolated from human peripheral blood using a |
| | Percoll gradient method and stimulated with 50 ng/ml of |
| | Phorbol-12-myristate-13-acetate (PMA) for 2 hours at 37° C. |
| Week 4 mast cell | Mast cells were derived from human cord blood using a ficoll |
| | density gradient and differentiated to mature mast cells over four |
| | weeks using 100 ng/ml stem cell factor, 10 ng/ml IL-10 and 5 ng/ml |
| | IL-6. Gene expression was then examined. |
| Week 9 mast cell | Mast cells were derived from human cord blood using a ficoll |
| | density gradient and differentiated to mature mast cells over nine |
| | weeks using 100 ng/ml stem cell factor, 10 ng/ml IL-10 and 5 ng/ml |
| | IL-6. Gene expression was then examined. |
| ImDC | Immature DC were generated by culture of human monocytes |
| | with recombinant IL-4 (800 U/ml) and GM-CSF (1500 U/ml). |
| DC6 | Immature DC were stimulated for 6 h with 100 ng/ml LPS. |
| DC48 | Immature DC were stimulated for 48 h with 100 ng/ml LPS. |

TABLE 10
Description of GeneChip comparison

| Microarray Comparison | |
|---|---|
| GeneChip | Description |
| NHBE IL-13 vs control | NHBE cells were obtained commercially from Clonetics |
| | (San Diego, CA) and stimulated with 10 ng/ml of IL-13 for |
| | 18 hours at 37° C. This GeneChip compared gene expression |
| | of IL-13 stimulated NHBEs to unstimulated NHBEs. |
| NHBE IL-4 vs control | NHBE cells were obtained commercially from Clonetics |
| | (San Diego, CA) and stimulated with 10 ng/ml of IL-4 for |
| | 18 hours at 37° C. This GeneChip compared gene expression |
| | of IL-4 stimulated NHBEs to unstimulated NHBEs |
| BSMC IL-13 vs control | BSMCs were obtained commercially from Clonetics (San |
| | Diego, CA) and stimulated with 10 ng/ml of IL-13 for 18 |
| | hours at 37° C. This GeneChip compared gene expression of |
| | IL-13 stimulated BSMCs to unstimulated BSMCs. |
| Mast IgE vs control | Mast cells were derived from human cord blood using a |
| | ficoll density gradient and differentiated to mature mast |
| | cells over 6-7 weeks using 100 ng/ml stem cell factor, 10 ng/ml |
| | IL-10 and 5 ng/ml IL-6. Once mature, cells were first |
| | primed with 4 μg/ml human IgE anti-NP for 18 hours and |
| | then activated with 5 μg/ml mouse anti-human IgE for 2 |
| | hours by crosslinking the IgE receptors. This GeneChip |
| | compared gene expression of unstimulated mast cells to |
| | those stimulated with IgE. |
| Mast week 9 vs week 4 | Mast cells were derived from human cord blood using a |
| | ficoll density gradient and differentiated to mature mast |
| | cells over time using 100 ng/ml stem cell factor, 10 ng/ml |
| | IL-10 and 5 ng/ml IL-6. This GeneChip compares gene |
| | expression of four week-old mast cells to nine week-old |
| | mast cells. |
| OA control vs RA control | Synovial tissue was obtained from Osteoarthritis (OA) and |
| | RA patients undergoing surgery at St Vincent's Hospital, |
| | Sydney, Australia. This tissue was used to establish |
| | fibroblast-like synoviocyte cultures. The cultures used for |
| | GeneChip studies were derived from biopsies taken from |
| | two knee biopsy samples from 37 and 38 year old women. |
| | This GeneChip compared gene expression of unstimulated |
| | synoviocyte cultures from OA and RA patients. |
| OA TNF vs OA control | Synoviocytes from OA patients were stimulated with 10 ng/ml |
| | of the cytokine TNF-α for 4 hours at 37° C. This |
| | GeneChip compared gene expression of unstimulated |
| | synoviocyte cultures from OA patients to those stimulated |
| | with TNF-α. |
| OA TNF vs RA TNF | This GeneChip compared synoviocyte cultures from OA |
| | patients that were stimulated with TNF-α to synoviocytes |
| | cultures from RA patients that were stimulated with TNF-α. |
| RATNF vs RA control | RA patients were stimulated with 10 ng/ml of the cytokine |
| | TNF-α for 4 hours at 37° C. This GeneChip compared gene |
| | expression of synoviocyte cultures from RA |
| RA IL-1 vs RA control | Synoviocytes from RA patients were stimulated with 10 ng/ml |
| | of the cytokine IL-1β for 4 hours at 37° C. This |
| | GeneChip compared gene expression of unstimulated |
| | synoviocyte cultures from RA patients to those stimulated |
| | with IL-1β. |
| RA IL-4 vs RA control | Synoviocytes from RA patients were stimulated with 10 ng/ml |
| | of the cytokine IL-4 for 4 hours at 37° C. This |
| | GeneChip compared gene expression of unstimulated |
| | synoviocyte cultures from RA patients to those stimulated |
| | with IL-4. |
| α4β7 vs CLA | CLA is a marker for skin homing effector memory T cells |
| | and α4β7, an integrin adhesion molecule is a marker for gut |
| | homing effector memory T cells. These cells were isolated |
| | from human peripheral blood using cell sorting. This Gene |
| | Chip compares gene expression in skin homing (CLA) T |
| | cells to gut homing (α4β7) T cells. |
| CD57+ vs CD57− | CD57+ (CXCR5+, CD4+) representing T Follicular |
| | Homing cells and CD57− (CXCR5+, CD4+) were isolated |
| | from human tonsil tissue using cell sorting. This GeneChip |
| | compares gene expression in T follicular homing cell subset |
| | (CD57+) to non T follicular homing cells (CD57−). |
| CD8+ CCR7− RO− vs RO+ | CD8+ CCR7− RO− and cytotoxic terminally differentiated T |
| | cells (CD8+ CCR7− RO+) were isolated from human |
| | peripheral blood using cell sorting. This GeneChip |
| | compares gene expression in cytotoxic effector memory T |
| | cells (RO−) to cytotoxic terminally differentiated (RO+) T |
| | cells. |
| Th2 vs Th1 | CD4+ T cells were isolated from human umbilical cord |
| | blood and polarized in vitro using IL-12 and neutralizing IL- |
| | 4 for TH1 and polarized in vitro using IL-4 and neutralizing |
| | IL-12 and interferon γ. The gene expression in TH1 cells |
| | were then compared with TH2. |

### EXAMPLE 10

### Asthma Candidate Gene:aP2

To identify candidate genes in human bronchial epithelial (HBE) cells, gene expression profiles were compared in control- and IL-4/IL-13-stimulated-HBE cells. One of the genes most strongly up-regulated by either IL-4 or IL-13 was aP2. aP2 expression was not known to be regulated by IL-4 or IL-13. A related gene, mal1 was also identified as a potential therapeutic target for asthma.

Bronchial epithelial cells are active participants in the asthmatic inflammatory response. To model the transcriptional events that take place at the bronchial epithelium during the asthmatic inflammatory response, HBE were stimulated with the allergy-associated cytokines IL-4 and IL-13. The experiment was performed using independent HBE lines. Increased expression of the adipocyte gene, aP2, was observed in the cytokine stimulated HBE cells (Table 3).

To confirm the microarray results, real-time PCR was employed; the results using this technology corresponded closely to our earlier microarray finding (Table 4).

Using a microarray database aP2 expression was examined in a range of other inflammatory cell types. Limited aP2 expression was found in other inflammatory microarray paradigms. Only mature mast cells were consistently found to express aP2. In mast cells, aP2 expression was unchanged following 2 h activation by FcεR1 cross-linking. Expression of aP2 protein was found in human dendritic cells using western blotting.

AP2 was originally considered to be an adipocyte specific gene and the finding of aP2 expression in primary bronchial epithelial cells was unexpected. Using real-time PCR, aP2 gene expression in these cells was further characterised. Following stimulation with IL-4 or IL-13, aP2 gene expression was upregulated as early as 1 h, with maximal expression detected at 24-48 h post-stimulation. Expression fell away rapidly by 72 h, approaching that of unstimulated cells.

A range of stimuli was tested for their ability to regulate aP2 expression in HBE cells. IL-1, IL-3, IL-6, IL-10, TNFα and LPS had no effect on aP2 expression. However, the prototypic type 1 cytokine, IFNγ, strongly downregulated aP2 expression in HBE cells. PMA stimulation resulted in a slight downregulation. In a subsequent experiment, PPARγ-ligand rosiglitazone and the PPARα-ligand WY14643 was found to have little or no effect on aP2 expression.

Mal1 is a fatty acid binding protein that has been functionally associated with aP2. The microarray data indicated that mal1 was present in HBE and that its expression was mildly up-regulated by IL-4 and IL-13. Real-time PCR was used to confirm and extend these results. IL-4 and IL-13 both upregulated mal1 expression with similar kinetics in HBE cells, although the degree of regulation was considerably lower than that observed for aP2.

Using a microarray database expression of mal1 was examined in a range of other inflammatory cell types. In contrast to the results obtained for aP2, mal1 expression occurred in a broad range of cell types but its expression was not strongly regulated in the inflammatory array systems.

Immunofluorescence staining was used to confirm that increased aP2 gene expression resulted in corresponding changes in aP2 protein expression. The intensity of aP2 staining in IL-4- or IL-13-stimulated HBE cells was considerably greater than that observed in unstimulated HBE cells. In IL-4- or IL-13-stimulated cells, a significant nuclear localisation of aP2 was consistently observed. This is consistent with the proposed involvement of aP2 in shuttling lipophilic ligands into the nucleus for nuclear receptors such as PPARγ.

As IL-4 and IL-13 are major contributors to the development of allergic inflammation, it was sought to analyse aP2 expression in a mouse model of asthma. AP2 expression in the lungs of control mice was mostly restricted to airway epithelium, with occasional deposits of fat showing intense aP2 expression. A similar pattern of expression was observed in mice with OVA-induced allergic inflammation. However, the intensity of staining was considerably higher than that observed in control mice.

To validate aP2 and mal1 as asthma target genes, aP2 knock out mice, mal1 knock out mice and aP2/mal1 double knock out mice were used. The results provide a clear indication of the importance of these fatty acid binding proteins in allergic inflammation. The aP2 knock out mouse is described in Hotamisligil et al., Science 274:1377-1379, 1996. The mal1 knock out mice are described in Maedia et al., Diabetes 52:300-307, 2003. The aP2/mal1 double knock out mice are described in Kim et al, Abstract 227-OR American Diabetes Association Annual Meeting, 2003.

C57BL6, aP2 knock out (KO), mal1 KO and aP2/mal1 KO mice are immunized i.p on days 0 and 14 with 100 μg OVA in alum. On days 28, 30, 33, 34 the mice are exposed to an aerosol of ovalbumin (1% w/v ovalbumin in PBS) generated by a Vitalair RapidNeb nebuliser (Allersearch, Australia). The mice are killed on day 35.

Cells are obtained from the airways by broncholveolar lavage. A total- and differential-cell count is obtained. The draining lymph node cells are collected and cultured at 4.5×10⁵ cells/ml for 3 days in RPMI-10% v/v FCS+L-glutamine. After 72 h the culture supernatants are collected, and IL-4 and IL-5 are measured by ELISA (Pharmingen).

There is a marked difference in the degree of allergic airway inflammation in the single KO mice compared to the aP2/mal1 DKO mice, as measured by differential counts of cells obtained from bronchial lavage as well as by cytokine production by draining lymph node cells. Markedly increased numbers of eosinophils and lymphocytes are observed in lung sections from aP2 KO and mal1 KO compared to DKO and WT mice. In this experiment, the extent of inflammation in the wild-type mice is lower than routinely obtain in this model, and a major finding is the near-complete absence of inflammation in the double KO mice.

In summary, enhanced expression of the fatty acid binding proteins aP2 and mal1 in HBE cells stimulated with the Th2 cytokines IL-4 and IL-13 is observed. Conversely, the type 1 cytokine IFNg down-regulated expression of aP2 and mal1. Increased aP2 expression in the airway epithelium of mice undergoing OVA-induced allergic airway inflammation. Using aP2, mal1 and aP2/mal1 KO mice, clear evidence of the involvement of both aP2 and mal1 in the mouse model of asthma.

### EXAMPLE 11

### Expression of aP2 Protein in Human Upper Airway Tissue

Nasal turbinate samples were obtained from patients undergoing nasal surgery. The samples were frozen in OCT Mounting Medium and stored at −80° C. Sections 8 μm thick were cut and air-dried for 15 min. The sections were fixed in 1% v/v paraformaldehyde/TBS for 20 min and washed once in TBS. The sections were quenched with 0.3% v/v H₂O₂ in methanol for 20 min and washed for 5 min in TBS-T. The sections were then blocked with normal goat serum (1:5 dilution in 2% w/v BSA/TBS) for 60 min, after which the primary Ab (1:1000 dilution in 2% w/v BSA/TBS) was added and the sections incubated overnight at room temperature (RT). The sections were washed 3× in TBS-T and goat anti-rabbit Ig-biotin (1:100) was added for 1 h at RT. The sections were washed 3 times in TBS-T, and streptavidin-HRP (1:100) was added for 40 min at RT. After washing 3× in TBS-T, color was developed with 3,3′ diaminobenzidine followed by counterstaining with Giemsa stain.

For the differentiation of DCs, monocytes were isolated from blood of healthy volunteers. Briefly, peripheral blood mononuclear cells were isolated over a density gradient centrifugation using Ficoll Paque (Pharmacia). Using anti-CD14 magnetic beads (Miltenyi BioTec) in accordance to the manufacturer's protocol, monocytes were labeled and isolated through positive selection. Monocytes were then differentiated into DCs by addition of the cytokines IL-4 (800 U/ml) and GM-CSF (1500 U/ml) (BD Pharmigen) in RPMI 1640 medium (GibcoBRL), supplemented with 10% heat inactivated FCS (GibcoBRL), 0.5 U/ml penicillin, 0.5 μg/ml streptomycin and 2 mM L-glutamine. Cells were incubated at 37° C. with 5% CO₂ in a humidified incubator. At day 5 floating immature DCs were harvested from still adherent cells and transferred to new plates to synchronize the differentiation of the cells. For activation/maturation, DCs were stimulated with LPS (100 ng/ml) for 6 or 48 hours.

Nasal turbinate samples were stained with a monoclonal antibody specific for human aP2. Intense staining restricted to airway epithelium was observed. Minimal staining was observed outside of the airway eptihelium.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

### BIBLIOGRAPHY

Baltimore, J. Virol. 54: 401-407, 1985
Bandyopadhyay and Temin, Mol. Cell. Biol. 4: 749-754, 1984
Baugh et al., Nucleic Acids 29(5): E29, 2001
Berglund et al., Biotechnology 11: 916-920, 1993
Berkner et al., BioTechniques 6; 616-629, 1988
Berkner, Curr. Top. Microbiol. Immunol. 158: 39-66, 1992
Breakefield and Geller, Mol. Neurobiol. 1: 339-371, 1987
Buchschacher and Panganiban, J. Virol. 66: 2731-2739, 1982
Coligan et al., “Current Protocols in Immunology, John Wiley & Sons, Inc., 1991-1997
Davies, Curr. Opin. Allergy Clin. Immunol. 1(1): 67-71, 2001
Erickson et al., Science 249: 527-533, 1990
Fink et al., Ann. Rev. Neurosci. 19: 265-287, 1996
Fink et al., Hum. Gene Ther. 3: 11-19, 1992
Finkelman et al., J. Immunol. 141(7): 2335-2341, 1988
Fodor et al., Science 251: 767-777, 1991
Foster et al., Pharmacol. Ther. 94(3): 253-264, 2002
Freese et al., Biochem. Pharmacol. 40: 2189-2199, 1990
Gefter et al., Somatic Cell Genet. 3: 231-236, 1977
Goeddel et al., Nucleic Acids Res. 8: 4057-1980
Gorziglia and Kapikian, J. Virol. 66: 4407-4412, 1992
Helseth et al., J. Virol. 64: 2416-2420, 1990
Hodgson, Bio/Technology 9: 19-21, 1991
Holgate et al., Clin. Exp. Allergy 29(2): 90-95, 1999
Hotamisligil et al., Science 274:1377-1379, 1996
Johnson et al., “Peptide Turn Mimetics” in Biotechnology and Pharmacy, Pezzuto et al., Eds., Chapman and Hall, New York, 1993
Johnson et al., J. Virol. 66: 2952-2965, 1992
Jordan et al., J. Clin. Invest. 104(8): 1061-1069, 1999
Kazal et al. (Nature Medicine 2: 753-759, 1996
Kennet et al., Monoclonal Antibodies and Hybridomas: A New Dimension in Biological Analyses, pp 376-384, Plenum Press, New York, 1980
Kim et al, Abstract 227-OR American Diabetes Association Annual Meeting, 2003
Kohler and Milstein, Eur. J. Immunol. 6(7): 511-519, 1976
Köhler and Milstein, Nature 256: 495-499, 1975
Kozbor et al., Methods in Enzymology 121: 140, 1986
Lawn et al., Nucleic Acids Res. 2: 6103, 1981
Leckie et al., Lancet 356(9248): 2144-2148, 2000
Lewis et al., J. Pathol. 195: 66-71, 2001
Mackay et al., Nucleic Acids Res 30(6): 1292-1305, 2002
Madzak et al., J. Gen. Virol. 73: 1533-1536, 1992
Maedia et al., Diabetes 52:300-307, 2003
Margolskee, Curr. Top., Microbiol. Immunol. 158: 67-95, 1992
Miller et al., J. Virol. 62: 4337-4345, 1988
Miller et al., Mol. Cell. Biol. 5: 431-437, 1985;
Miller, Curr. Top. Microbiol. Immunol. 158: 1-24, 1992;
Moss, Curr. Top. Microbiol. Immunol. 158: 25-38, 1992
Moss, Proc. Natl. Acad. Sci. USA 93: 11341-11348, 1996
Mullis et al., Quant. Biol. 51: 263, 1987; Erlich, eds., PCR Technology, Stockton Press, NY, 1989
Munder et al., Appl. Microbiol. Biotechnol. 52(3): 311-320, 1999
Muzyczka, Curr. Top. Microbiol. Immunol. 158: 97-129, 1992
Naldini et al., Science 272: 263-267, 1996
O'Reilly et al., Biotechniques 25: 824-830, 1998
Ohi et al., Gene 89: 279-282, 1990
Page et al., J. Virol. 64: 5270-5276, 1990
Petropoulos et al., J. Viol. 66: 3391-3397, 1992
Punnonen et al., Proc. Natl. Acad. Sci. USA 90(8): 3730-3740, 1993
Quantin et al., Proc. Natl. Acad. Sci. USA 89: 2581-2584, 1992
Remington's Pharmaceutical Sciences, 18^{th} Ed. (1990, Mack Publishing, Company, Easton, Pa., U.S.A.
Rosenfeld et al., Cell 68: 143-155, 1992
Rozen and Skaletsky, Methods Mol. Biol. 132: 365-386, 2000
Russell and Hirata, Nature Genetics 18: 323-328, 1998
Schneider et al., Nature Genetics 18: 180-183, 1998
Shimada et al., J. Clin. Invest. 88: 1043-1047, 1991
Shulman et al., Nature 276: 269-270, 1978
Sorge et al., Mol. Cell. Biol. 4: 1730-1737, 1984
Stratford-Perricaudet et al., Hum. Gene Ther. 1: 241-256, 1990
Summerton and Weller, Antisense and Nucleic Acid Drug Development 7: 187-195, 1997
Toyama et al., Monoclonal Antibody, Experiment Manual”, published by Kodansha Scientific, 1987
Trowbridge, J. Exp. Med. 148(1): 313-323, 1978
Volk et al., J. Virol. 42(1): 220-227, 1982
Walker, J. Biochem. Mol. Toxicology 15(3): 121-127, 2001
Wells, Methods Enzymol. 202: 2699-2705, 1991
Wills-Karp, Annu. Rev. Immunol. 17: 255-281, 1999
Wilkinson et al., Nucleic Acids Res. 20: 2233-2239, 1992
Young et al., Nat. Biotechnol. 16(10): 946-950, 1998

1-38. (canceled)

39. A method for the treatment or prophylaxis of inflammation of normal mammalian bronchial epithelial cells said method comprising administering to a subject a therapeutic agent which effects a composition selected from the group consisting of FABP-4 (aP2) and FABP-5 (mal1).

40. The method of claim 39 wherein the mammalian bronchial epithelial cells are human bronchial epithelial cells.

41. The method of claim 39 wherein the agent reduces the level of one or both said compositions.

42. The method of claim 39 wherein the agent reduces the activity of one or both said compositions.

43. The method of claim 39 wherein the agent is administered as an inhalant.

44. The method of claim 39 wherein the subject is a human.

45. The method of claim 39 for the treatment of asthma.

46. The method of claim 39 wherein the agent is a heterocyclic containing biphenyl compound of Formula I 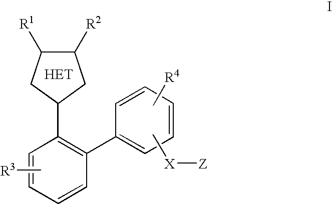
wherein:
R¹ and R² are the same or different and are independently selected from the group consisting of H, alkyl, cycloalkyl, cycloalkenyl, aryl, heteroaryl, heteroarylalkyl, aralkyl, cycloheteroalkyl and cycloheteroalkylalkyl;
R³ is selected from the group consisting of hydrogen, halogen, alkyl, alkenyl, alkynyl, alkoxy, cycloalkyl, cycloalkylalkyl, cycloalkenyl, alkylcarbonyl, cycloheteroalkyl, cycloheteroalkylalkyl, cycloalkenylalkyl, haloalkyl, polyhaloalkyl, cyano, nitro, hydroxy, amino, alkanoyl, alkylthio, alkylsulfonyl, alkoxycarbonyl, alkylaminocarbonyl, alkylcarbonylamino, alkylcarbonyloxy, alkylaminosulfonyl, alkylamino, dialkylamino, all optionally substituted through available carbon atoms with 1, 2, 3, 4 or S groups selected from hydrogen, halo, alkyl, polyhaloalkyl, alkoxy, haloalkoxy, polyhaloalkoxy, alkoxycarbonyl, alkenyl, alkynyl, cycloalkyl, cycloalkylalkyl, cycloheteroalkyl, cycloheteroalkylalkyl, hydroxy, hydroxyalkyl, nitro, cyano, amino, substituted amino, alkylamino, dialkylamino, thiol, alkylthio, alkylcarbonyl, acyl, alkoxycarbonyl, aminocarbonyl, alkynylaminocarbonyl, alkylaminocarbonyl, alkenylaminocarbonyl, alkylcarbonyloxy, alkylcarbonylamino, alkoxycarbonylamino, alkylsulfonyl, aminosulfinyl, aminosulfinyl, alkylsulfinyl, sulfonamido and sulfonyl;
R⁴ is selected from the group consisting of hydrogen, halogen, alkyl, alkenyl, alkynyl, alkoxy, aryl, heteroaryl, arylalkyl, heteroarylalkyl, arylalkenyl, arylalkynyl, cycloalkyl, cycloalkylalkyl, polycycloalkyl, polycycloalkylalkyl, cycloalkenyl, cycloalkynyl, alkylcarbonyl, arylcarbonyl, cycloheteroalkyl, cycloheteroalkylalkyl, cycloalkenylalkyl, polycycloalkenyl, polycycloalkenylalkyl, polycycloalkynyl, polycycloalkynylalkyl, haloalkyl, polyhaloalkyl, cyano, nitro, hydroxy, amino, alkanoyl, aroyl, alkylthio, alkylsulfonyl, arylsulfonyl, alkoxycarbonyl, aryloxycarbonyl, alkylaminocarbonyl, arylaminocarbonyl, alkylcarbonylamino, alkylcarbonyloxy, alkylaminosulfonyl, arylaminosulfonyl, alkylamino, dialkylamino, all optionally substituted through available carbon atoms with 1, 2, 3, 4 or S groups selected from hydrogen, halo, alkyl, haloalkyl, polyhaloalkyl, alkoxy, haloalkoxy, polyhaloalkoxy, alkoxycarbonyl, alkenyl, alkynyl, cycloalkyl, cycloalkylalkyl, cycloheteroalkyl, cycloheteroalkylalkyl, aryl, heteroaryl, arylalkyl, arylcycloalkyl, arylalkenyl, arylalkynyl, aryloxy, aryloxyalkyl, arylalkoxy, arylazo, heteroaryloxo, heteroarylalkyl, heteroarylalkenyl, heteroaryloxy, hydroxy, hydroxyalkyl, nitro, cyano, amino, substituted amino, alkylamino, dialkylamino, thiol, alkylthio, arylthio, heteroarylthio, arylthioalkyl, alkylcarbonyl, arylcarbonyl, acyl, arylaminocarbonyl, alkoxycarbonyl, aminocarbonyl, alkynylaminocarbonyl, alkylaminocarbonyl, alkenylaminocarbonyl, alkylcarbonyloxy, arylcarbonyloxy, alkylcarbonylamino, arylcarbonylamino, alkoxycarbonylamino, arylsulfinyl, arylsulfinylalkyl, arylsulfonyl, alkylsulfonyl, aminosulfinyl, aminosulfonyl, arylsulfonylamino, heteroarylcarbonylamino, heteroarylsulfinyl, heteroarylthio, heteroarylsulfonyl, alkylsulfonyl, sulfonamido and sulfonyl;
X is a bond or a linker group selected from the group consisting of (CH₂)ₙ, O(CH₂)ₙ, S(CH₂)ₙ, NHCO, CH═CH, cycloalkylene and N(R⁵)(CH₂)ₙ, (where n=0-5 and R⁵ is selected from the group consisting of H, alkyl, and alkanoyl;
Z is selected from the group consisting of CO₂H and tetrazole of the formula 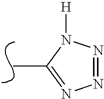
or its tautomer; and
the group 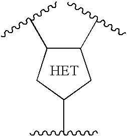
represents a heterocyclic group (including heteroaryl and cycloheteroalkyl groups) preferably containing 5-members within the ring and containing preferably 1-3 heteroatoms within the ring, and which may further optionally include one or two substituents selected from the group consisting of alkyl, alkenyl, hydroxyalkyl, keto, carboxyalkyl, carboxy, cycloalkyl, alkoxy, formyl, alkanoyl, alkoxyalkyl and alkoxycarboxyl;
with the provisos that:
(1) n≠o when Z is CO₂H and X is O(CH₂)ₙ, S(CH₂)ₙ or N(R⁵)(CH₂)ₙ); and
(2) when 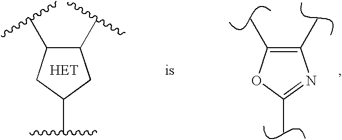
then X-Z may not be O-lower alkylene-CO₂H or —O-lower alkylene-CO₂alkyl when R¹ and R² are both aryl or substituted aryl and R³ and R⁴ are each hydrogen;
or a stereoisomers of said compound.

47. The method of claim 46 wherein the group 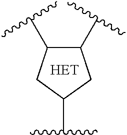
comprises a compound selected from the group consisting of a heteroaryl group and a cycloheteroalkyl group wherein said compound is selected from the group consisting of 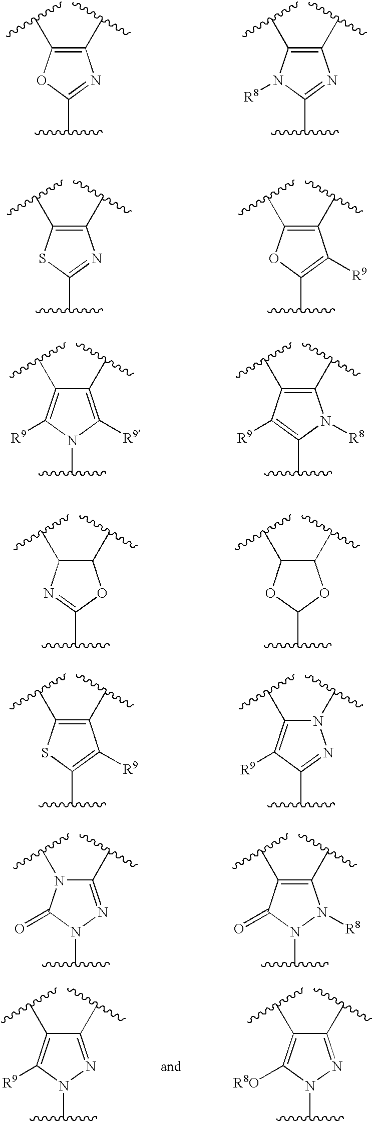
wherein:
R⁸ is selected from the group consisting of H, alkyl, haloalkyl, hydroxyalkyl, alkoxyalkyl, and alkenyl, and
R⁹ and R^{9′} are the same or different and are selected independently from the group consisting of H, alkyl, alkoxy, alkenyl, formyl, CO₂H, CO₂ (lower alkyl), hydroxyalkyl, alkoxyalkyl, CO(alkyl), carboxylalkyl, haloalkyl, alkenyl and cycloalkyl.

48. The method of claim 47 wherein any of said alkyl or alkyl-containing groups of R⁸, R⁹ and R^{9′} includes 1 to 6 carbons.

49. The method of claim 46 wherein X-Z moieties are selected from the group consisting of

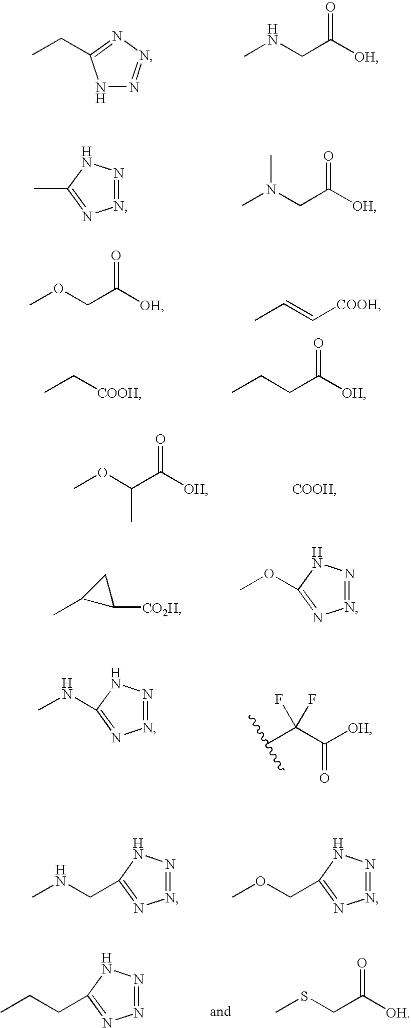

50. The method of claim 46 wherein: 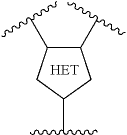
is selected from the group consisting of 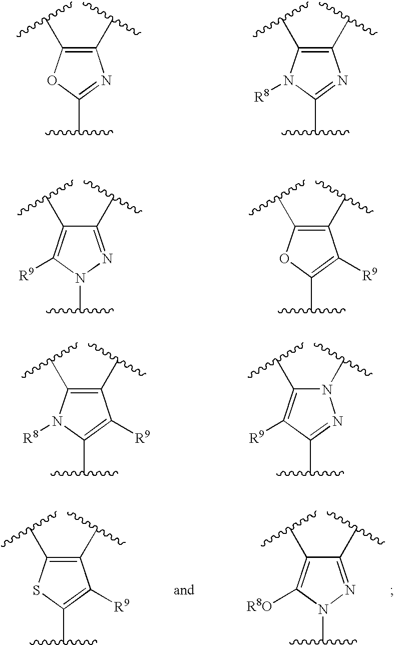
R⁸ is selected from the group consisting of hydrogen, alkyl, fluoroalkyl and alkoxyalkyl, and where R⁹ is selected from the group consisting of hydrogen, alkyl, fluoroalkyl, alkoxy and hydroxyalkyl;
R¹ and R² are each selected from the group consisting of phenyl, substituted phenyl and cycloalkyl;
R³ and R⁴ are the same or different and are independently selected from the group consisting of H, halo, alkyl and alkoxy; X is selected from the group consisting of OCH₂, NHCH₂, CH₂ and CH₂CH₂; and
Z is selected from the group consisting of CO₂H and tetrazole.

51. The method of claim 46 wherein 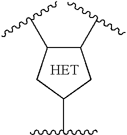
is selected from the group consisting of 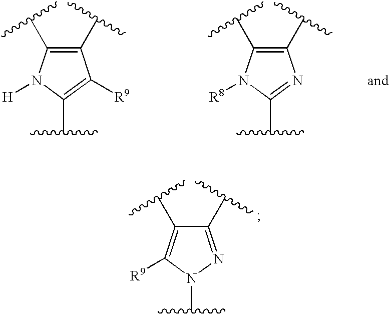
wherein:
R⁸ is hydrogen, alkyl or fluoroalkyl;
R⁹ is hydrogen, alkyl, fluoroalkyl or alkoxy;
R¹ and R² are each phenyl;
R³ and R⁴ are each H; X is OCH₂, CH₂ or NHCH₂; and
Z is CO₂H or tetrazole.

52. Use of a compound selected from the group consisting of FABP-4 and FABP-5 in the manufacture of a medicament for the treatment of inflammation of normal bronchial epithelial cells.

53. Use of claim 52 wherein said inflammation is associated with asthma.

54. A method for the diagnosis of inflammation of normal bronchial epithelial cells, a propensity for development of such inflammation or for monitoring the efficacy of a therapeutic protocol to treat said inflammation, said method comprising determining the pattern of expression of FABP-4 or FABP-5 wherein up-regulated levels of FABP-4 or FABP-5 or the proteins encoded thereby is indicative of said inflammation.

55. The method of claim 54 wherein the inflammatory condition is associated with asthma.
